(19) United States
(12) Patent Application Publication
(10) Pub. No.: US 2026/0017350 A1
(43) Pub. Date: Jan. 15, 2026

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Takeru KOIE, Saitama (JP); Yasushi TAKAHASHI, Fukuoka (JP)

(21) Appl. No.: 19/335,442

(22) Filed: Sep. 22, 2025

Related U.S. Application Data
(63) Continuation of application No. PCT/JP2024/006505, filed on Feb. 22, 2024.
(60) Provisional application No. 63/456,612, filed on Apr. 3, 2023.

(51) Int. Cl. G06F 21/10; H04L 9/30; H04L 9/32

(52) U.S. Cl. CPC G06F 21/1014; H04L 9/30; H04L 9/3271

(57) ABSTRACT

An information processing method includes: receiving a presentation request for presenting a content that is a Non-Fungible Token (NFT); verifying, by using a public key of an owner of the content, whether a transmitter of the presentation request received is the owner of the content; and performing presentation processing for presenting the content, when the transmitter of the presentation request received is verified to be the owner of the content.

### CROSS REFERENCE TO RELATED APPLICATIONS

This is a continuation application of PCT International Application No. PCT/JP2024/006505 filed on Feb. 22, 2024, designating the United States of America, which is based on and claims priority of U.S. Provisional Patent Application No. 63/456,612 filed on Apr. 3, 2023. The entire disclosures of the above-identified applications, including the specifications, drawings and claims are incorporated herein by reference in their entirety.

### FIELD

The present disclosure relates to an information processing method, an information processing system, and a recording medium.

### BACKGROUND

A method for generating or using a crypto digital asset in the form of a Non-Fungible Token (NFT) by means of a distributed ledger has been proposed (see PTL 1).

### CITATION LIST

### Patent Literature

PTL 1: Japanese Translation of PCT International Application Publication No. 2022-514466

### SUMMARY

### Technical Problem

In a conventional method, histories of the generation of a crypto digital asset by a user and the like recorded in a distributed ledger can be referred to by another user. This raises such a problem that information about the user is not protected.

Hence, the present disclosure provides an information processing method capable of presenting an NFT while protecting information about a user.

### Solution to Problem

An information processing method according to an aspect of the present disclosure includes: receiving a presentation request for presenting a content that is a Non-Fungible Token (NFT); verifying, by using a public key of an owner of the content, whether a transmitter of the presentation request received is the owner of the content; and performing presentation processing for presenting the content, when the transmitter of the presentation request received is verified to be the owner of the content.

General or specific aspects of the present disclosure may be implemented to a system, a device, a method, an integrated circuit, a computer program, a computer-readable recording medium such as a Compact Disc-Read Only Memory (CD-ROM), or any given combination thereof.

### Advantageous Effects

The present disclosure makes it possible to present an NFT while protecting information about a user.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating the general configuration of an information processing system in Embodiment 1.

FIG. 2 is a block diagram illustrating the functional configuration of a presentation server in Embodiment 1.

FIG. 3 is a block diagram illustrating the functional configuration of a ledger server in Embodiment 1.

FIG. 4 is an explanatory diagram illustrating the data structure of a blockchain in Embodiment 1.

FIG. 5 is an explanatory diagram illustrating the data structure of transaction data in Embodiment 1.

FIG. 6 is an explanatory diagram illustrating transaction data items pertaining to the execution of a smart contract in Embodiment 1.

FIG. 7 is an explanatory diagram illustrating a process pertaining to the execution of the smart contract in Embodiment 1.

FIG. 8A is a sequence diagram illustrating the process of registering an NFT by the information processing system in Embodiment 1.

FIG. 8B is a sequence diagram illustrating a variation of the process of registering the NFT by the information processing system in Embodiment 1.

FIG. 9 is an explanatory diagram illustrating registration information on the NFT in Embodiment 1.

FIG. 10 is a sequence diagram illustrating the process of transferring the NFT by the information processing system in Embodiment 1.

FIG. 11 is an explanatory diagram illustrating registration information on the NFT in Embodiment 1.

FIG. 12 is a first sequence diagram illustrating the process of presenting the NFT by the information processing system in Embodiment 1.

FIG. 13 is a second sequence diagram illustrating the process of presenting the NFT by the information processing system in Embodiment 1.

FIG. 14 is an explanatory diagram illustrating the NFT presented in Embodiment 1.

FIG. 15 is a sequence diagram illustrating the process of registering an agent by the information processing system in Variation 1 of Embodiment 1.

FIG. 16 is an explanatory diagram illustrating registration information on the NFT in Variation 1 of Embodiment 1.

FIG. 17 is a sequence diagram illustrating the process of transferring the NFT by the information processing system in Variation 1 of Embodiment 1.

FIG. 18 is an explanatory diagram illustrating registration information on the NFT in Variation 1 of Embodiment 1.

FIG. 19 is a sequence diagram illustrating the process of performing remittance processing by the information processing system in Variation 2 of Embodiment 1.

FIG. 20 is an explanatory diagram illustrating remittance information in Variation 2 of Embodiment 1.

FIG. 21 is a schematic diagram illustrating the general configuration of an information processing system in Embodiment 2.

FIG. 22 is a block diagram illustrating the functional configuration of a management device in Embodiment 2.

FIG. 23 is a first sequence diagram illustrating the process of registering an NFT by the information processing system in Embodiment 2.

FIG. 24 is an explanatory diagram illustrating registration information on the NFT in Embodiment 2.

FIG. 25 is an explanatory diagram illustrating sub-registration information on the NFT in Embodiment 2.

FIG. 26 is a second sequence diagram illustrating the process of registering the NFT by the information processing system in Embodiment 2.

FIG. 27 is an explanatory diagram illustrating sub-registration information on the NFT in Embodiment 2.

FIG. 28 is a first sequence diagram illustrating the process of transferring the NFT by the information processing system in Embodiment 2.

FIG. 29 is a second sequence diagram illustrating the process of transferring the NFT by the information processing system in Embodiment 2.

FIG. 30 is an explanatory diagram illustrating sub-registration information on the NFT in Embodiment 2.

FIG. 31 is a sequence diagram illustrating the process of presenting the NFT by the information processing system in Embodiment 2.

### DESCRIPTION OF EMBODIMENTS

### (Underlying Knowledge Forming Basis of the Present Disclosure)

The present inventors found that the method for generating or using a crypto digital asset by means of a distributed ledger, which has been described in the section “Background,” raises the following problems.

Information recorded in the distributed ledger can be referred to by all users using the distributed ledger. As a result, a conventional method has such a problem that information about a user recorded in a distributed ledger is not protected.

Specifically, in the conventional method, histories of the generation of a crypto digital asset by a user and the like recorded in the distributed ledger can be referred to by all users using the distributed ledger. As a result, a user who generated or owned a crypto digital asset in the past or a user who currently owns the crypto digital asset can be identified by other users. This raises such a problem that information about the user recorded in the distributed ledger is not protected.

Hence, the present disclosure provides an information processing method capable of making an NFT available while protecting information about a user.

Hereinafter, aspects of the invention derived from the content of the disclosure of the present description will be described by way of example, and the effects and the like derived from the aspect of the invention will be described.

(1) An information processing method including: receiving a presentation request for presenting a content that is a Non-Fungible Token (NFT); verifying, by using a public key of an owner of the content, whether a transmitter of the presentation request received is the owner of the content; and performing presentation processing for presenting the content, when the transmitter of the presentation request received is verified to be the owner of the content.

According to this aspect, a server can verify whether the transmitter of the presentation request is the owner of the content, using the public key of the owner of the content. In the verification, the server need not use identification information on the owner of the content. Thus, the server can control the presentation of the NFT while protecting information about the owner of the content. Accordingly, the server can control the presentation of the NFT while protecting information about a user.

(2) The information processing method according to (1), wherein the presentation request includes identification information for identifying the NFT that is a target to be presented in response to the presentation request, and the verifying includes: obtaining the public key of the owner from a distributed ledger in which the public key is stored in association with the identification information included in the presentation request; and verifying whether a creator of the presentation request received is the owner of the content, by a challenge-response method using the public key obtained.

According to this aspect, the server can easily perform the verification through a verification by the challenge-response method using the public key of the owner stored in the distributed ledger. Since the public key of the owner of the content is stored in the distributed ledger, it is virtually impossible to tamper with the public key of the owner, bringing about the effect of appropriately performing the verification of the owner of the content. Accordingly, the server can present the NFT more appropriately while protecting information about the user.

(3) The information processing method according to (2), further including: storing the public key used in the verifying as a first public key when the transmitter of the presentation request received is verified to be the owner of the content; obtaining, as a second public key, the public key of the owner from the distributed ledger in which the public key is stored, when further verifying the owner of the content after the storing of the public key as the first public key; determining whether the second public key obtained matches the first public key; and performing presentation processing for presenting the content, when the second public key obtained is determined to match the first public key.

According to this aspect, when performing a further verification, the server can verify the owner without communication for the verification (e.g., verification by the challenge-response method) by determining whether the first public key stored matches the second public key stored in the distributed ledger. The server can present the NFT with less processing while protecting information about the user.

(4) The information processing method according to (1), wherein the presentation request includes identification information for identifying the NFT that is a target to be presented in response to the presentation request, and the verifying includes; obtaining verification information generated by using the public key of the owner, the public key being securely stored in a storage device; and verifying whether the transmitter of the presentation request received is the owner, by a challenge-response method using the verification information obtained.

According to this aspect, the server can easily perform the verification through a verification by the challenge-response method using the public key of the owner securely stored in the storage device. Since the public key of the owner of the content is securely stored in the storage device, it is virtually impossible to tamper with the public key of the owner, bringing about the effect of appropriately performing the verification of the owner of the content. In the case where an information processing system is configured such that the accessing of the storage device is performed by means of a smart contract by a user of the information processing system, the accessing of the storage device can be limited such that a person other than a user of the information processing system cannot refer to the public key of the owner of the content. Accordingly, the server can present the NFT more appropriately while protecting information about the user.

(5) An information processing system including: a server; and a terminal, wherein the server includes: a communication unit that receives, from the terminal, a presentation request for presenting a content that is a Non-Fungible Token (NFT); a verifier that verifies, by using a public key of an owner of the content, whether a transmitter of the presentation request received by the communication unit is the owner of the content; and a presenter that performs presentation processing for presenting the content by the terminal, when the transmitter of the presentation request received is verified to be the owner of the content.

The aspect provides the same effects as with the information processing method.

(6) A program for causing a computer to execute the information processing method according to (1).

The aspect provides the same effects as with the information processing method.

General or specific aspects of the present disclosure may be implemented to a system, a device, a method, an integrated circuit, a computer program, a computer-readable recording medium such as a Compact Disc-Read Only Memory (CD-ROM), or any given combination thereof.

Hereinafter, certain exemplary embodiments will be described in detail with reference to the accompanying Drawings.

The following embodiments are specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

### Embodiment 1

In the present embodiment, an information processing method and an information processing system that are capable of presenting an NFT while protecting information about a user will be described.

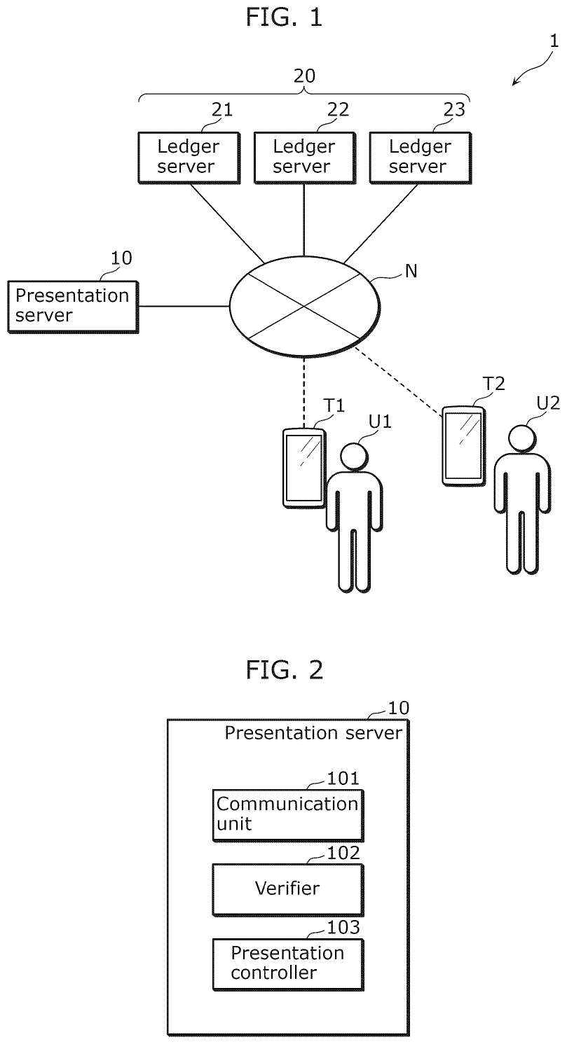

FIG. 1 is a schematic diagram illustrating the general configuration of information processing system 1 in the present embodiment.

As illustrated in FIG. 1, information processing system 1 includes presentation server 10, distributed ledger system 20, and terminal T1. Information processing system 1 may further include terminal T2.

Presentation server 10 is a server being a computer controlling the presentation of a content that is a Non-Fungible Token (NFT) (also simply referred to as a content). When receiving a presentation request for presenting a content, presentation server 10 controls the presentation of the content. Presentation server 10 is capable of controlling the presentation of an NFT while protecting information about a user.

The content can include a digital content such as an image content, a video content, a sound content, or a text content. The digital content can be specifically an artwork, a photograph, a game, an article, or the like. Note that the content may include information indicating some kind of right or privilege (also referred to as a right or the like). For example, the content may include the right or the like to enter or participate in a given space, embark on a ship or an airplane, or board a vehicle.

Distributed ledger system 20 is a system that has and manages a distributed ledger. The distributed ledger stores information about NFTs (specifically, histories of the generation or dealing of the NFTs, etc.).

Distributed ledger system 20 includes ledger servers 21, 22, and 23 as a group of servers storing the distributed ledger. Note that the number of ledger servers included in the group of servers is not limited to three. The number may be greater than three or less than three.

Ledger server 21 is a server being a computer that stores and manages the distributed ledger. Ledger server 21 has the distributed ledger and updates the distributed ledger while synchronizing the distributed ledger with other ledger servers such as ledger server 22.

Ledger servers 22 and 23 are servers similar to ledger server 21 and operate independently of ledger server 21.

Terminal T1 is an information terminal owned by user U1. User U1 can be the owner of a content. The information terminal is a device including a communication interface, an input-output device (a display screen, a speaker, etc.), a processor (a Central Processing Unit (CPU), etc.), and a storage device. For example, the information terminal is a smartphone, a tablet computer, or a personal computer. The same applies hereinafter.

Terminal T1 is capable of performing the process of registering a content owned by user U1 as an NFT, the process of transferring an NFT owned by user U1 to user U2, or the process of presenting a content owned by user U1. The processes performed by terminal T1 will be described in detail later.

Terminal T2 is an information terminal owned by user U2. User U2 can be a user to whom a content is to be transferred from user U1.

Terminal T2 is capable of performing the process of transferring an NFT owned by user U1 to user U2. The process performed by terminal T2 will be described in detail later.

FIG. 2 is a block diagram illustrating the functional configuration of presentation server 10 in the present embodiment.

As illustrated in FIG. 2, presentation server 10 includes, as functional units, communication unit 101, verifier 102, and presentation controller 103. Verifier 102 and presentation controller 103 can be implemented by a processor (e.g., a central processing unit (CPU)) included in presentation server 10 executing a given computer program using a memory.

Communication unit 101 is a communication interface that is connected to network N so as to perform communication.

Communication unit 101 may be a communication interface conforming to a wired communication standard (e.g., Ethernet (Registered Trademark), etc.), a communication interface conforming to a wireless communication standard (e.g., Wi-Fi (Registered Trademark), etc., or a mobile communications system (3G, 4G, or 5G, etc.)). Communication unit 101 is used when functional units included in presentation server 10 communicate with another device.

Verifier 102 verifies information received from terminal T1 or the like. Specifically, when receiving a presentation request for presenting a content, verifier 102 verifies, by using a public key of user U1 who is the owner of the content, whether the transmitter of the received presentation request is user U1, who is the owner of the content.

Note that verifier 102 is also capable of verifying, in the case where the information received from terminal T1 or the like includes a digital signature (also simply referred to as a signature), the signature by using a public key of a person who has put the signature.

The presentation request includes identification information for identifying an NFT that is a target to be presented in response to the presentation request. In the verification in this case, verifier 102 can obtain the public key of the owner from the distributed ledger in which the public key is stored in association with the identification information included in the presentation request and verify whether the creator of the received presentation request is the owner of the content by a challenge-response method using the obtained public key of the owner.

Presentation controller 103 performs control pertaining to the presentation of a content. In the case where the verification performed by verifier 102 when a presentation request for presenting a content is received has succeeded (in other words, when the creator of the received presentation request is verified to be the owner of the content), presentation controller 103 performs presentation processing for presenting the content. The presentation processing can include, for example, the process of transmitting the content to terminal T1. In this case, terminal T1 can receive and present the transmitted content. For example, in the case where the content includes an image content, presenting the content by terminal T1 includes displaying the image content on the display screen, and in the case where the content includes a sound content, presenting the content by terminal T1 includes outputting the sound content from the speaker.

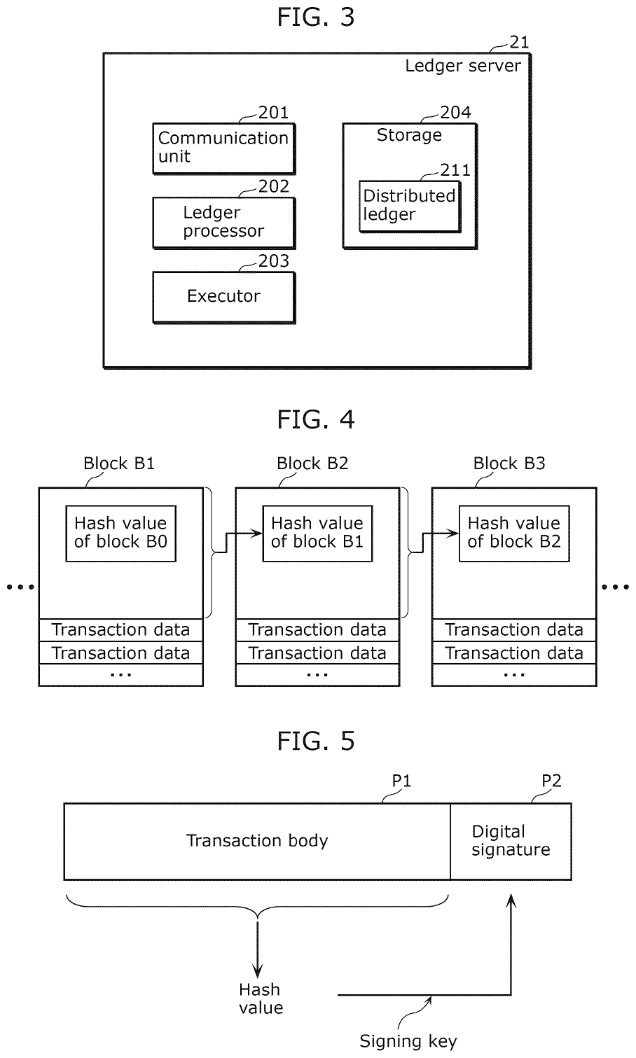

FIG. 3 is a block diagram illustrating the functional configuration of ledger server 21 in the present embodiment.

Ledger server 21 includes communication unit 201, ledger processor 202, executor 203, and storage 204.

Communication unit 201 is a communication interface that is connected to network N so as to perform communication. Communication unit 201 may be a communication interface conforming to a wired communication standard (e.g., Ethernet (Registered Trademark), etc.), a communication interface conforming to a wireless communication standard (e.g., Wi-Fi (Registered Trademark), etc., or a mobile communications system (3G, 4G, or 5G, etc.)). Communication unit 201 is used when functional units included in ledger server 21 communicate with another device.

Ledger processor 202 performs a process pertaining to distributed ledger 211 or transaction data. Specifically, when receiving the transaction data from presentation server 10, terminal T1, or the like, ledger processor 202 performs control such that the signature of the received transaction data is verified, and that when the verification succeeds, the transaction data is stored in distributed ledger 211 in storage 204. To store the transaction data in distributed ledger 211, ledger processor 202 performs control such that a block in which the transaction data is to be stored is generated, a consensus algorithm for the generated block is executed with ledger processor 202 of each of ledger servers 22 and 23, which are the other ledger servers, and the block is stored in distributed ledger 211 when a consensus is reached. Note that, as the consensus algorithm, Practical Byzantine Fault Tolerance (PBFT) may be used, or Proof of Work (POW), Proof of Stake (POS), or the like may be used. Note that, in the case where Hyperledger fabric is used as an example of a distributed ledger technology, the consensus algorithm need not be executed.

Executor 203 executes information processing. For example, executor 203 can execute the information processing by executing a smart contract. This case will be described by way of example. Note that, in the case where no smart contract is used, executor 203 executes the processing according to a conventional program code.

When transaction data including instructions to execute the smart contract is stored in distributed ledger 211, executor 203 reads a contract code of the smart contract from distributed ledger 211 and executes the smart contract.

Executor 203 manages the association between an NFT and the public key of an owner of the NFT. Executor 203 manages the association between the NFT and the public key of the owner of the NFT, using registration information stored in distributed ledger 211.

Using the registration information, executor 203 can perform a process pertaining to the NFT (specifically, the process of registering, transferring, or presenting the NFT). The registration information has no registration of information with which the owner of the NFT can be identified. Thus, the registration information has such a feature that the owner of the NFT cannot be identified by another user referring to distributed ledger 211.

Storage 204 is a storage device storing information. Storage 204 stores distributed ledger 211. Storage 204 is implemented with a nonvolatile storage device (a Solid State Drive (SSD) or a Hard Disk Drive (HDD)) or the like.

Distributed ledger 211 includes data having a structure in which blocks each including one or more transaction data items are linked to form a chain.

The transaction data includes transaction data indicating the delivery of a token between users. The token includes at least a Non-Fungible Token (NFT). The token may include common value information (a monetary value or information equivalent to a monetary value).

The transaction data includes, for each NFT, registration information in which identification information on the NFT is associated with the public key of an owner of the NFT (see FIG. 9, etc.). In the registration information, for each NFT, identification information of the NFT (also referred to as an NFT-ID), the public key of the owner of the NFT, and identification information indicating the NFT (specifically, a Uniform Resource Identifier (URI)) are stored in association with one another.

The transaction data also includes transaction data including the contract code of a smart contract, transaction data including instructions to execute the smart contract, or transaction data including the other information.

With reference to FIG. 4 to FIG. 7, the data structure of a blockchain, which is an example of the distributed ledger, and the execution of a smart contract will be described.

FIG. 4 is an explanatory diagram illustrating the data structure of the blockchain.

In the blockchain, blocks, which are recording units of the blockchain, are connected to form a chain. Each of the blocks includes a plurality of transaction data items and the hash value of its previous block.

FIG. 4 illustrates blocks B1, B2, and B3 included in the blockchain.

For example, block B2 includes the hash value of block B1, the previous block. The hash value of block B1 is a hash value calculated by computation performed on the content of block B1 by a hash algorithm.

Block B3 includes a hash value calculated from the plurality of transaction data items included in block B2 and the hash value of block B1, as the hash value of block B2.

As seen from the above, the blockchain has the structure in which the blocks each including the content of its previous block in the form of a hash value are connected to form a chain. Thus, the blockchain can effectively prevent tampering with recorded transaction data.

If a past transaction data item is altered (in other words, tampered with), the hash value of the block including the transaction data item differs from the value before the alteration. In this case, in order to make the block including the altered transaction data item appear authentic, it is necessary to rebuild all the blocks following the block, which includes the altered transaction data item, in the distributed ledger stored in each of multiple servers. This task is extremely difficult in reality. These characteristics can make it substantially impossible to tamper with a transaction data item included in a blockchain.

FIG. 5 is an explanatory diagram illustrating the data structure of transaction data.

The transaction data illustrated in FIG. 5 includes transaction body P1 and digital signature P2. Transaction body P1 is the data body included in the transaction data. Digital signature P2 is generated by encrypting the hash value of transaction body P1 with a signing key of the creator of the transaction data (in other words, a private key).

With digital signature P2, it is substantially impossible to tamper with the transaction data. These characteristics can make it substantially impossible to tamper with the data included in the transaction body.

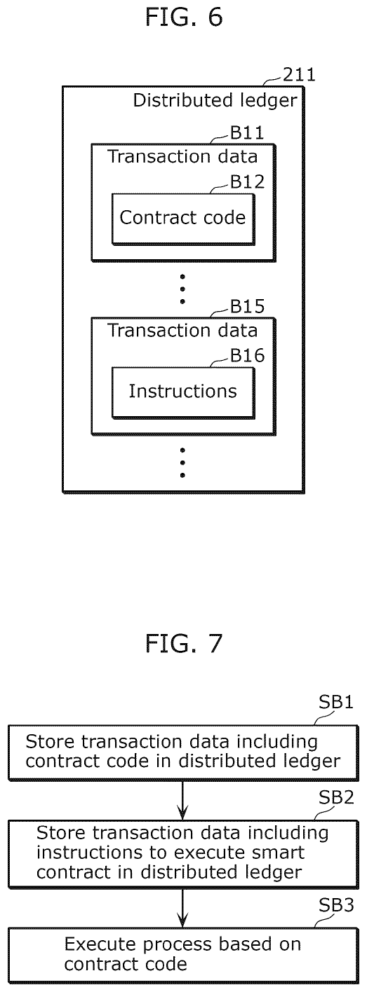

FIG. 6 is an explanatory diagram illustrating transaction data items pertaining to the execution of a smart contract in the present embodiment. FIG. 7 is an explanatory diagram illustrating a process pertaining to the execution of the smart contract in the present embodiment.

With reference to FIG. 6 and FIG. 7, a series of steps pertaining to the execution of the smart contract will be described.

In step SB1, ledger processor 202 stores, in distributed ledger 211, transaction data B11 including contract code B12 in which a process for the smart contract is written. Step SB1 is performed before the execution of the smart contract.

In step SB2, ledger processor 202 stores, in distributed ledger 211, transaction data B15 including instructions B16 to execute the smart contract.

In step SB3, executor 203 executes the process based on the contract code in response to the storing of transaction data B15 including instructions B16 in distributed ledger 211 in step SB2. The result of the process by executor 203 can be included in a transaction data item and stored in distributed ledger 211.

By the series of steps, upon receiving transaction data B15 including instructions 16 to execute the smart contract, distributed ledger system 20 executes the process according to instructions 16 automatically (in other words, with no manual operations). Thus, it is possible to execute the process with high efficiency (in other words, at high speed or in a short time). Achieving highly efficient processing brings about the effect of the reduction in power consumption. In addition, dispensing with manual operations makes it possible to avoid tampering or misconduct by a person, or a human error before it happens. Furthermore, since the result of the process executed in such a manner is stored in a blockchain, it is substantially impossible to tamper with the result of the process.

Hereinafter, processes performed by information processing system 1 will be described specifically. The processes performed by information processing system 1 include (1) the process of registering an NFT, (2) the process of transferring the NFT, and (3) the process of presenting the NFT.

### (1) Process of Registering NFT

The process of registering an NFT is the process of registering a content to be managed as the NFT, as the NFT of the owner of the content. Here, the process of registering a content owned by user U1 as an NFT will be described.

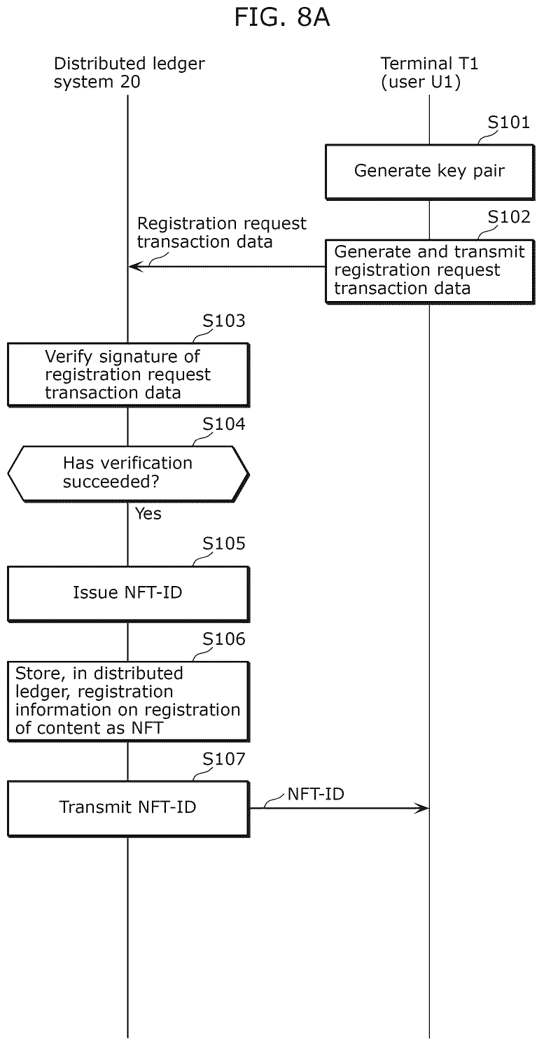

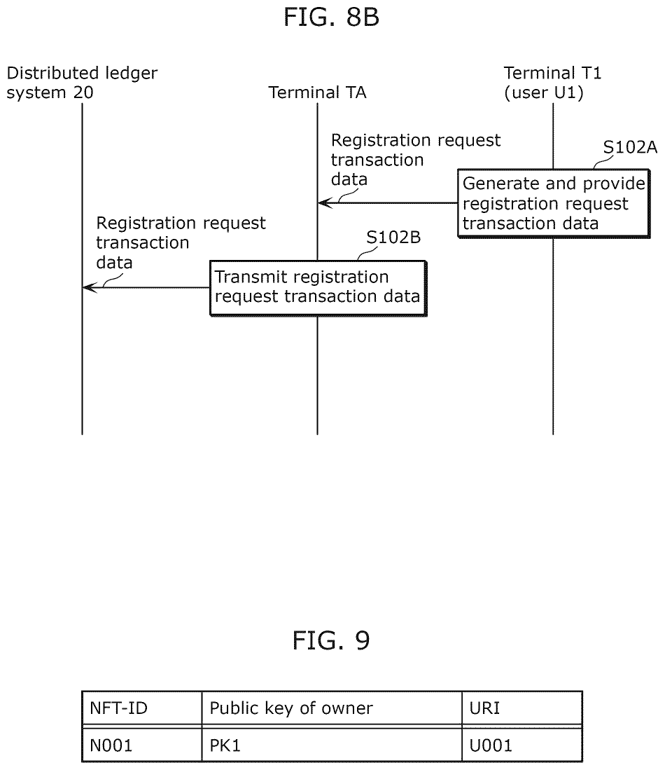

FIG. 8A is a sequence diagram illustrating the process of registering an NFT by information processing system 1 in the present embodiment. FIG. 9 is an explanatory diagram illustrating registration information on the NFT in the present embodiment. With reference to FIG. 8A and FIG. 9, the process performed by information processing system 1 to register the NFT will be described.

At the time of performing step S101, terminal T1 stores the content to be managed as an NFT. The content is stored in a storage device accessible over network N. Terminal T1 has the URL of the content.

In step S101, terminal T1 generates a key pair of user U1. The generated key pair is a pair of private key SK1 and public key PK1.

Note that a private key and a public key of one key pair “correspond” to each other. For example, private key SK1 is a private key corresponding to public key PK1, and public key PK1 is a public key corresponding to private key SK1. The same applies hereinafter.

Note that if terminal T1 generates a different key pair for the registration of each NFT, this brings about such an advantage that signature S (SK1) calculated in step S103 (described later) using at least public key PK1 can be made differ for the registration of a corresponding NFT. The same applies hereinafter.

In step S102, terminal T1 generates registration request transaction data and transmits the generated registration request transaction data to a ledger server included in distributed ledger system 20. Here, the description will be given on the assumption that “the ledger server included in distributed ledger system 20” is ledger server 21 as an example. The ledger server may be another ledger server included in distributed ledger system 20, ledger server 22 or 23. The same applies hereinafter.

Ledger server 21 receives the transmitted registration request transaction data and causes ledger processor 202 to store the received registration request transaction data in distributed ledger 211.

The registration request transaction data is transaction data including a request for registering the content owned by user U1 as an NFT. The registration request transaction data includes the URI of the content, public key PK1 of user U1, and signature S (SK1) generated using private key SK1 of user U1.

Note that signature S (SK1) is, for example, a value obtained by encrypting, with the private key of user U1, a hash value output from a hash algorithm receiving the URI of the content and public key PK1 of user U1. The description will be given along with this case. Note that if different public key PK1 is used for the registration of each NFT, this brings about such an advantage that signature S (SK1) calculated using at least public key PK1 can be made differ for the registration of a corresponding NFT, thus enabling a replay attack to be prevented before it happens.

Note that a value input into the hash algorithm to calculate signature S (SK1) may be any value as long as the replay attack can be prevented before it happens. It will suffice if the value is independent of any other values, for example.

In step S103, executor 203 of ledger server 21 verifies the signature of the registration request transaction data received in step S102. In general, the signature of transaction data is verified by determining whether the value obtained by decrypting the signature included in the transaction data with the public key corresponding to a private key used to generate the signature matches a hash value used to generate the signature. When determining that the value obtained by the decryption matches the hash value, executor 203 determines that the verification succeeds, and when the value obtained by the decryption does not match the hash value, executor 203 determines that the verification fails. The same applies hereinafter. Note that the process of verifying the signature is applied to not only transaction data but also the verification of information including a signature.

In step S104, executor 203 of ledger server 21 determines whether the verification in step S103 has succeeded. When determining that the verification has succeeded (Yes in step S104), executor 203 of ledger server 21 proceeds to step S105, and when determining that the verification has failed, executor of ledger server 21 can execute an error process. Note that the illustration of a process performed when it is determined that the verification has failed is omitted for the sake of convenience. The error process may include a process of outputting information indicating that the verification has failed.

In step S105, executor 203 of ledger server 21 issues an NFT-ID.

In step S106, executor 203 of ledger server 21 stores, in distributed ledger 211, registration information on the registration of the content owned by user U1 as the NFT. An example of the registration information stored in distributed ledger 211 by executor 203 is illustrated in FIG. 9. The registration information includes “N001,” which is the NFT-ID of the NFT to be registered, public key PK1 of user U1 as the public key of the owner of the NFT, and “U001,” which is the URI of the NFT in association with one another.

In step S107, executor 203 of ledger server 21 transmits the NFT-ID issued in step S105 to terminal T1. Executor 203 can execute the transmission of the NFT-ID as a response to the registration request transaction data received in step S102.

Note that the process performed by executor 203 (specifically, steps S103 to S107) may be performed by the execution of a smart contract. In this case, the registration request transaction data transmitted in step S102 includes instructions to execute the smart contract for executing the process, and executor 203 can execute the process according to the instructions in response to the storing of the received registration request transaction data in distributed ledger 211 (step S102).

Note that, when the transaction data is transmitted to distributed ledger system 20 (i.e., ledger server 21), the transaction data may be transmitted to ledger server 21 by a different terminal from the terminal that has generated the transaction data. This applies to transaction data described later.

For example, the generation of the registration request transaction data and the transmission of the registration request transaction data to distributed ledger system 20 by terminal T1 in step S102 described above has been described. However, this may be performed as follows instead (see FIG. 8B). That is, terminal T1 may generate registration request transaction data and provide the registration request transaction data to terminal TA (corresponding to the “different terminal”) (step S102A), and terminal TA may obtain the provided registration request transaction data and transmit the registration request transaction data to distributed ledger system 20 (step S102B). In this case, the method in which terminal T1 provides the registration request transaction data to terminal TA may be a method using communication or may be a method of handing over a storage device storing the registration request transaction data.

As a result, terminal TA is recorded in the distributed ledger as the transmitter of the registration request transaction data. In other words, recording of terminal T1 that has generated the registration request transaction data (in other words, user U1) in the distributed ledger is avoided. This brings about such an effect that it is difficult to identify user U1 as the owner of the content by referring to the distributed ledger.

### (2) Process of Transferring NFT

The process of transferring an NFT is the process of transferring a content managed as the NFT from a current owner to another owner, in other words, registering the content as the NFT of the other owner. Here, the process of transferring a content owned by user U1 to user U2 will be described.

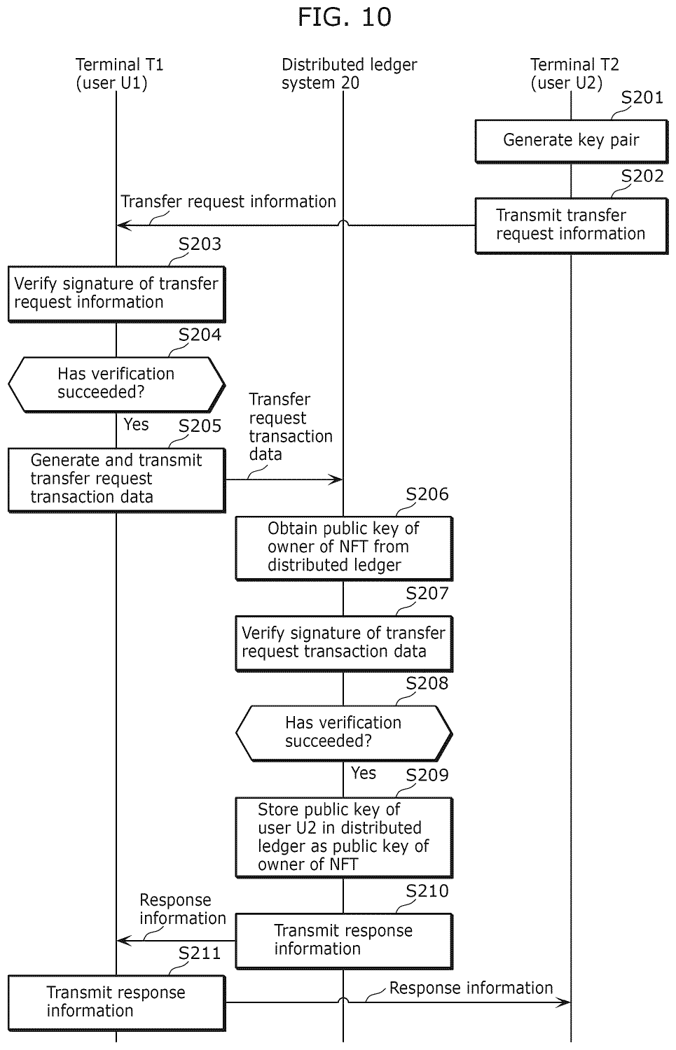

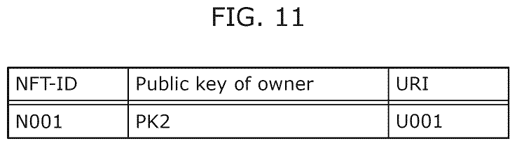

FIG. 10 is a sequence diagram illustrating the process performed by information processing system 1 to transfer the NFT in the present embodiment. FIG. 11 is an explanatory diagram illustrating registration information on the NFT in the present embodiment. With reference to FIG. 10 and FIG. 11, the process performed by information processing system 1 to transfer the NFT will be described.

In step S201, terminal T2 generates a key pair of user U2. The generated key pair is a pair of private key SK2 and public key PK2.

In step S202, terminal T2 generates transfer request information and transmits the generated transfer request information to terminal T1. Terminal T1 receives the transmitted transfer request information. The transfer request information includes public key PK2 of user U2 and signature S (SK2) generated using private key SK2 of user U2.

In step S203, terminal T1 verifies the signature of the transfer request information received in step S202.

In step S204, terminal T1 determines whether the verification in step S203 has succeeded. When determining that the verification has succeeded (Yes in step S204), terminal T1 proceeds to step S205, and when determining that the verification has failed, terminal T1 can execute an error process. Note that the illustration of a process performed when it is determined that the verification has failed is omitted for the sake of convenience. The error process may include a process of outputting information indicating that the verification has failed.

In step S205, terminal T1 generates transfer request transaction data and transmits the generated transfer request transaction data to ledger server 21. Ledger processor 202 of ledger server 21 receives the transmitted transfer request transaction data, and ledger processor 202 stores the received transfer request transaction data in distributed ledger 211. The transfer request transaction data includes an NFT-ID, public key PK2 of user U2, signature S (SK2), and signature S (SK1).

In step S206, executor 203 of ledger server 21 obtains public key PK1 as the public key of the owner of the NFT from distributed ledger 211. When executor 203 of ledger server 21 obtains the public key of the owner of the NFT from distributed ledger 211, executor 203 obtains public key PK1 of user U1, as the public key of the owner that is associated, in the registration information, with the NFT-ID included in the transfer request transaction data received in step S205.

In step S207, executor 203 of ledger server 21 verifies the signature of the transfer request transaction data received in step S205. At this time, ledger server 21 verifies signature S (SK1) and signature S (SK2) in the transfer request transaction data.

In step S208, executor 203 of ledger server 21 determines whether the verification in step S207 has succeeded. When determining that the verification has succeeded (Yes in step S208), executor 203 of ledger server 21 proceeds to step S209, and when determining that the verification has failed, executor 203 of ledger server 21 can execute an error process. Note that the illustration of a process performed when it is determined that the verification has failed is omitted for the sake of convenience. The error process may include a process of outputting information indicating that the verification has failed or a process of discarding the transfer request transaction data. The execution of the process of discarding the transfer request transaction data causes the transfer request transaction data not to be stored in a memory. It is thus possible to reduce unnecessary memory usage.

In step S209, executor 203 of ledger server 21 causes ledger processor 202 to store public key PK2 of user U2 included in the transfer request transaction data received in step S205 in distributed ledger 211 as the public key of the owner of the NFT. An example of the registration information in which public key PK2 is registered as the public key of the owner of the NFT is illustrated in FIG. 11. In FIG. 11, N001, which is the NFT-ID, is associated with public key PK2 of user U2 as the public key of the owner of the NFT.

In step S210, executor 203 of ledger server 21 transmits response information to terminal T1. Terminal T1 receives the transmitted response information. The response information is information indicating that public key PK2 of user U2 has been stored in distributed ledger 211 as the public key of the owner of the NFT. Executor 203 of ledger server 21 can execute the transmission of the response information as a response to the reception of the transfer request transaction data in step S205.

In step S211, terminal T1 transmits the response information to terminal T2. Terminal T2 receives the transmitted response information. Terminal T1 can execute the transmission of the response information as a response to the reception of the transfer request information in step S202. The response information can include the NFT-ID, public key PK2 of user U2, and a URI.

Note that the process performed by executor 203 (specifically, steps S206 to S210) may be performed by the execution of a smart contract. In this case, the transfer request transaction data transmitted in step S205 includes instructions to execute the smart contract for executing the process, and executor 203 can execute the process according to the instructions in response to the storing of the received transfer request transaction data in distributed ledger 211 (step S205).

### (3) Process of Presenting NFT

The process of presenting an NFT is the process of presenting a content managed as the NFT to a user on a terminal or the like. Here, the process of presenting a content owned by user U1 with terminal T1 of user U1 will be described.

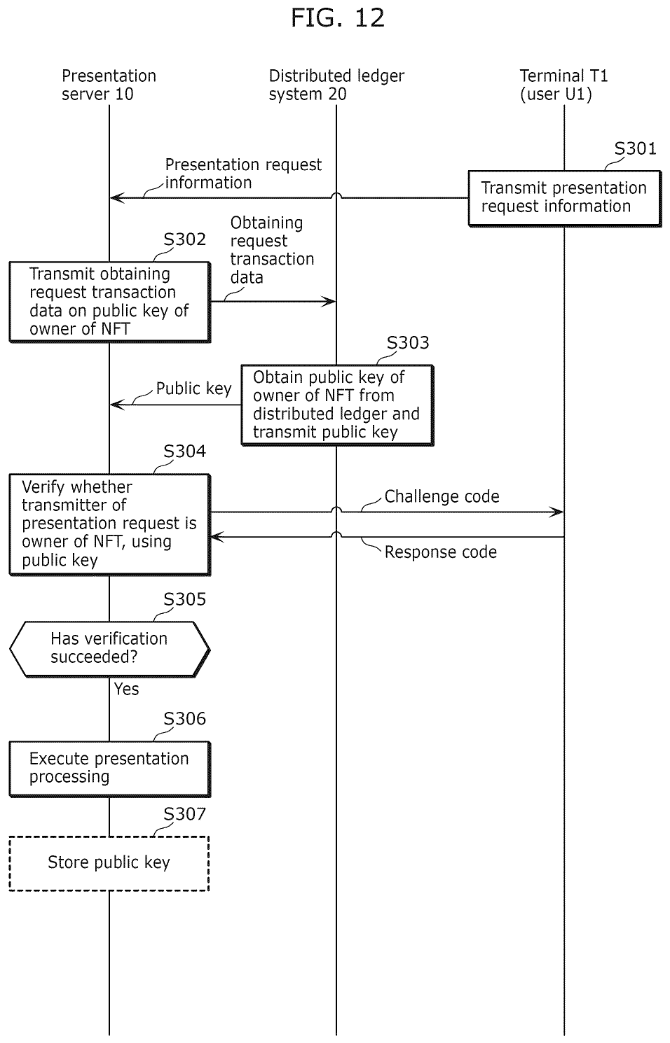

FIG. 12 is a first sequence diagram illustrating the process performed by information processing system 1 to present the NFT in the present embodiment.

In step S301, terminal T1 transmits presentation request information on the NFT (also simply referred to as a presentation request) to presentation server 10. Presentation server 10 receives the transmitted presentation request information. The presentation request information includes identification information on a transmitter of the presentation request, the address of a smart contract, and the NFT-ID of the NFT that is the target to be presented in response to the presentation request.

In step S302, verifier 102 of presentation server 10 transmits obtaining request transaction data on the public key of the owner of the NFT to ledger server 21. Ledger server 21 receives the transmitted obtaining request transaction data and causes ledger processor 202 to store the received obtaining request transaction data in distributed ledger 211. The obtaining request transaction data includes the NFT-ID of the NFT, which is the target to be presented.

Note that, instead of step S302 described above, verifier 102 of presentation server 10 may obtain the public key of the owner of the NFT by referring to the distributed ledger in ledger server 21.

In step S303, in response to the reception of the obtaining request transaction data in step S302, executor 203 of ledger server 21 obtains public key PK1 as the public key of the owner of the NFT from distributed ledger 211 and transmits the public key PK1 to presentation server 10. Presentation server 10 receives public key PK1 that has been transmitted.

In step S304, using public key PK1 received in step S303, verifier 102 of presentation server 10 verifies whether the transmitter of the presentation request information received in step S301 is the owner of the NFT. The verification can be performed using a challenge-response method. Specifically, verifier 102 of presentation server 10 transmits information obtained by encrypting a nonce with public key PK1 to terminal T1 as a challenge code. Terminal T1 decrypts the transmitted challenge code with private key SK1 of user U1 to obtain information and transmits the information to presentation server 10 as a response code. Presentation server 10 receives the transmitted response code and determines whether the received response code matches the nonce. When determining that the response code matches the nonce, presentation server 10 determines that the verification succeeds, and when determining that the response code does not match the nonce, presentation server 10 determines that the verification fails.

In step S305, verifier 102 of presentation server 10 determines whether the verification in step S304 has succeeded. When determining that the verification has succeeded (Yes in step S305), verifier 102 of presentation server 10 proceeds to step S306, and when determining that the verification has failed, verifier 102 of presentation server 10 can execute an error process. Note that the illustration of a process performed when it is determined that the verification has failed is omitted for the sake of convenience. The error process may include a process of outputting information indicating that the verification has failed or a process of presenting the content in a conventional mode.

In step S306, presentation controller 103 of presentation server 10 executes presentation processing of presenting the NFT. The presentation processing is processing of presenting a content being the NFT. In the case where the content includes an image content, the presentation processing includes the transmission of the data on the content to terminal T1 and the displaying of the image content on a display screen of terminal T1. The image content displayed on the display screen can be, for example, an image content displayed as a profile image for a Social Networking Service (SNS) (described later), or an image content indicating admission to a given space to user U1 who owns the NFT. In the case where the content includes a sound content, the presentation processing includes the transmission of the data on the content to terminal T1 and the output of the sound content from the speaker of terminal T1 in the form of sound.

In step S307, presentation server 10 stores the public key of the owner of the NFT. The stored public key can be used in the second and subsequent executions of the presentation processing on the NFT. Note that the process of step S307 is not essential. The process need not be executed.

Note that the process performed by executor 203 (specifically, step S303) may be performed by the execution of a smart contract. In this case, the obtaining request transaction data transmitted in step S302 includes instructions to execute the smart contract for executing the process, and executor 203 can execute the process according to the instructions in response to the storing of the received obtaining request transaction data in distributed ledger 211 (step S302).

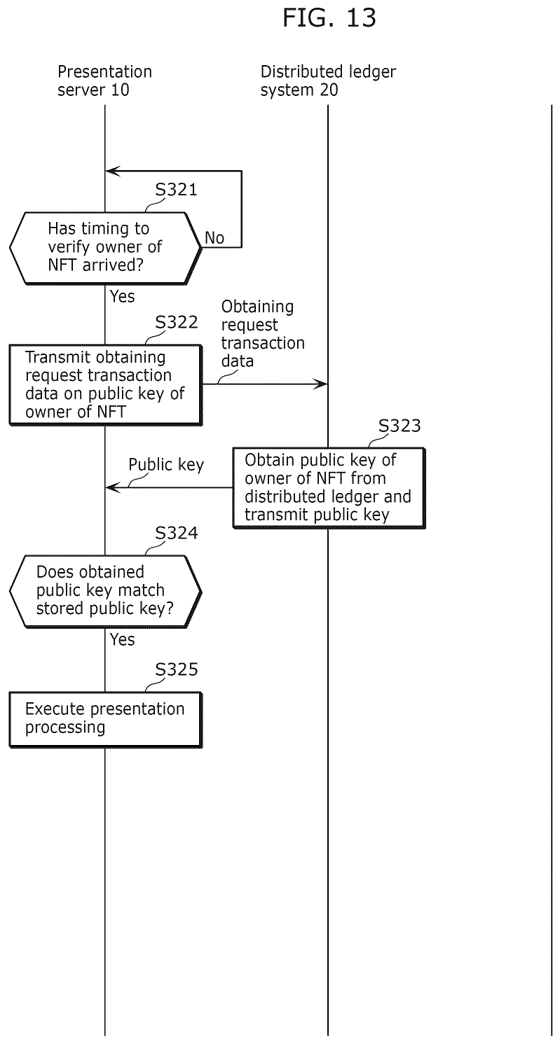

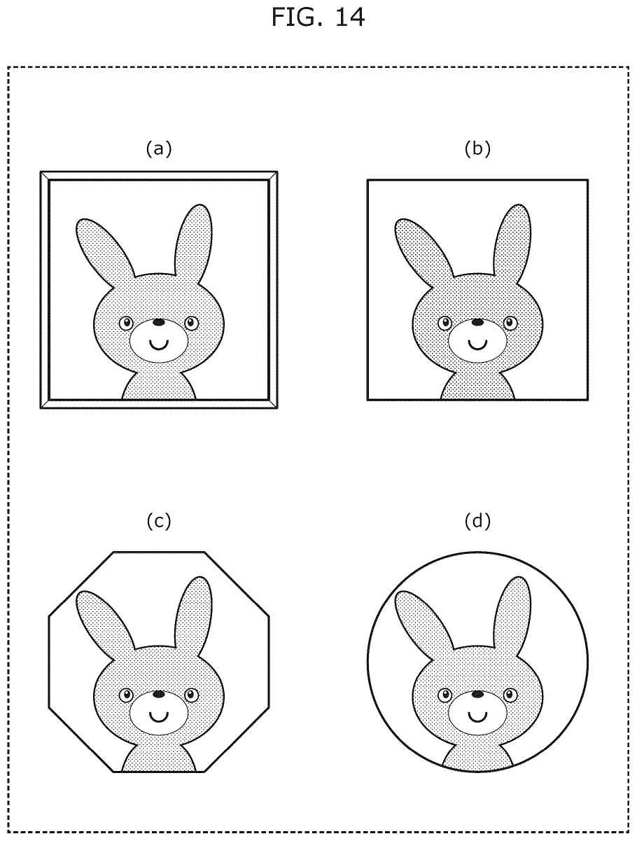

FIG. 13 is a second sequence diagram illustrating the process performed by information processing system 1 to present the NFT in the present embodiment.

A series of steps illustrated in FIG. 13 is executed to verify the owner of the NFT after the execution of the presentation processing on the NFT (step S306, see FIG. 12).

The series of steps illustrated in FIG. 13 can be executed by information processing system 1 in the case where the public key with which the verification whether the transmitter of the presentation request is the owner of the NFT has succeeded (Yes in step S305) (also referred to as a first public key) is stored (step S307) in presentation server 10.

When further verifying the owner after the storing of the first public key, presentation server 10 obtains the public key of the owner stored in distributed ledger 211 (also referred to as a second public key) and determines whether the obtained second public key matches the first public key. When determining that the second public key matches the first public key, presentation server 10 can execute the presentation processing for presenting the content. This will be described in detail later.

In step S321, presentation server 10 determines whether the timing to verify the owner of the NFT has arrived. In the case where the timing has arrived (Yes in step S321), the process proceeds to step S322, and in the case where the timing has not arrived (No in step S321), step S321 is executed again. In other words, presentation server 10 assumes a stand-by state in step S321 until the timing arrives. The timing to verify the owner of the NFT can be, for example, a timing after the lapse of a given time (about one hour through about several hours, about one day through about several days, about one month through about several months, etc.) since the presentation processing is executed on the NFT (step S306), a timing at which presentation server 10 is requested to update a content to be presented by another terminal, or the like.

In step S322, verifier 102 of presentation server 10 transmits obtaining request transaction data on the public key of the owner of the NFT to ledger server 21. Ledger server 21 receives the transmitted obtaining request transaction data and causes ledger processor 202 to store the received obtaining request transaction data in distributed ledger 211.

Note that, instead of step S322 described above, verifier 102 of presentation server 10 may obtain the public key of the owner of the NFT by referring to the distributed ledger in ledger server 21.

In step S323, in response to the reception of the obtaining request transaction data in step S322, executor 203 of ledger server 21 obtains public key PK1 as the public key of the owner of the NFT from distributed ledger 211 and transmits the public key PK1 to presentation server 10. Presentation server 10 receives public key PK1 that has been transmitted.

In step S324, verifier 102 of presentation server 10 determines whether the public key received in step S323 is the same as the stored public key (in other words, the public key stored in step S307 (see FIG. 12)). When it is determined that the two public keys are the same, the process proceeds to step S325, and when it is determined that the two public keys are not the same, an error process can be executed. Note that the illustration of the case where it is determined that the two public keys are not the same is omitted for the sake of convenience. The error process may be the same as the error process executed when it is determined in step S305 that the verification has failed.

In step S325, presentation controller 103 of presentation server 10 executes presentation processing of presenting the NFT. The presentation processing is the same as in step S306 (see FIG. 12).

Note that, in the series of steps illustrated in FIG. 13, in the case where the public key with which the verification whether the transmitter of the presentation request is the owner of the NFT has succeeded (Yes in step S305) is not stored (step S307) in presentation server 10. Information processing system 1 is to verify whether the transmitter of the presentation request is the owner of the NFT (i.e., the same verification as in step S304) instead of executing step S324 described above.

Note that the process performed by executor 203 (specifically, step S323) may be performed by the execution of a smart contract. In this case, the obtaining request transaction data transmitted in step S322 includes instructions to execute the smart contract for executing the process, and executor 203 can execute the process according to the instructions in response to the storing of the received obtaining request transaction data in distributed ledger 211 (step S322).

Accordingly, presentation server 10 can obtain the public key of the owner stored in distributed ledger 211 and verify whether the transmitter of the received presentation request is the owner by the challenge-response method using the obtained public key. In addition, when further verifying the owner, presentation server 10 can verify the owner without the communication for the verification (e.g., verification by the challenge-response method).

FIG. 14 is an explanatory diagram illustrating the NFT presented in the present embodiment.

FIG. 14 illustrates an example of image contents displayed on the display screen of terminal T1. The image contents illustrated in FIG. 14 are, for example, image contents displayed as profile images for an SNS.

(a) and (b) in FIG. 14 illustrate an example in which whether the content is the NFT is indicated as whether the content includes a picture frame or a frame border.

(a) in FIG. 14 illustrates an example of an image content displayed in a display mode for a content being an NFT. Specifically, the image illustrated in (a) in FIG. 14 includes the illustration of a rabbit with a picture frame surrounding the illustration of the rabbit. The display with the picture frame is the display mode for a content being an NFT.

(b) in FIG. 14 illustrates, as a point of comparison for (a) in FIG. 14, an example of an image content displayed in a display mode for a conventional content. Specifically, the image illustrated in (b) in FIG. 14 includes the illustration of a rabbit with a frame border surrounding the illustration of the rabbit. The display with the frame border is the display mode for a conventional content (in other words, a content not being an NFT).

Note that, instead of the picture frame included in the content, a frame border in a different mode from that of a conventional frame border (e.g., a frame border thicker than the conventional frame border, a frame border different from the conventional frame border in color or thickness, a frame border of a different line type (solid line, broken line, dash dot line, etc.) from the conventional frame border, or the like may be used.

(c) and (d) in FIG. 14 illustrate an example in which the shape of the frame border included in the content indicates whether the content is the NFT.

(c) in FIG. 14 illustrates an example of an image content displayed in a display mode for a content being an NFT. Specifically, the image illustrated in (c) in FIG. 14 includes the illustration of a rabbit with an octagonal frame border surrounding the illustration of the rabbit. The display with the octagonal frame border is the display mode for a content being an NFT.

(d) in FIG. 14 illustrates, as a point of comparison for (c) in FIG. 14, an example of an image content displayed in a display mode for a conventional content. Specifically, the image illustrated in (d) in FIG. 14 includes the illustration of a rabbit with a circular frame border surrounding the illustration of the rabbit. The display with the circular frame border is the display mode for a conventional content (in other words, a content not being an NFT).

Note that the shape of the frame border in the display mode for a content being an NFT is not limited to an octagonal shape. The shape may be any polygonal shape such as a hexagonal shape or may be any other shape. The frame border in the display mode for a content being an NFT and the frame border in the display mode for a conventional content may be inversed.

As seen from the above, information processing system 1 is capable of presenting an NFT while protecting information about a user.

### Variation 1 of Embodiment 1

In the present variation, there will be described a process performed by information processing system 1 in the case where an NFT is transferred by a person (also referred to as an agent) different from a user who is involved in the transfer of the NFT (i.e., an owner of the NFT before the transfer or an owner of the NFT after the transfer).

Here, the description will be given on the assumption that the agent is user U9, and a terminal owned by user U9 is terminal T9.

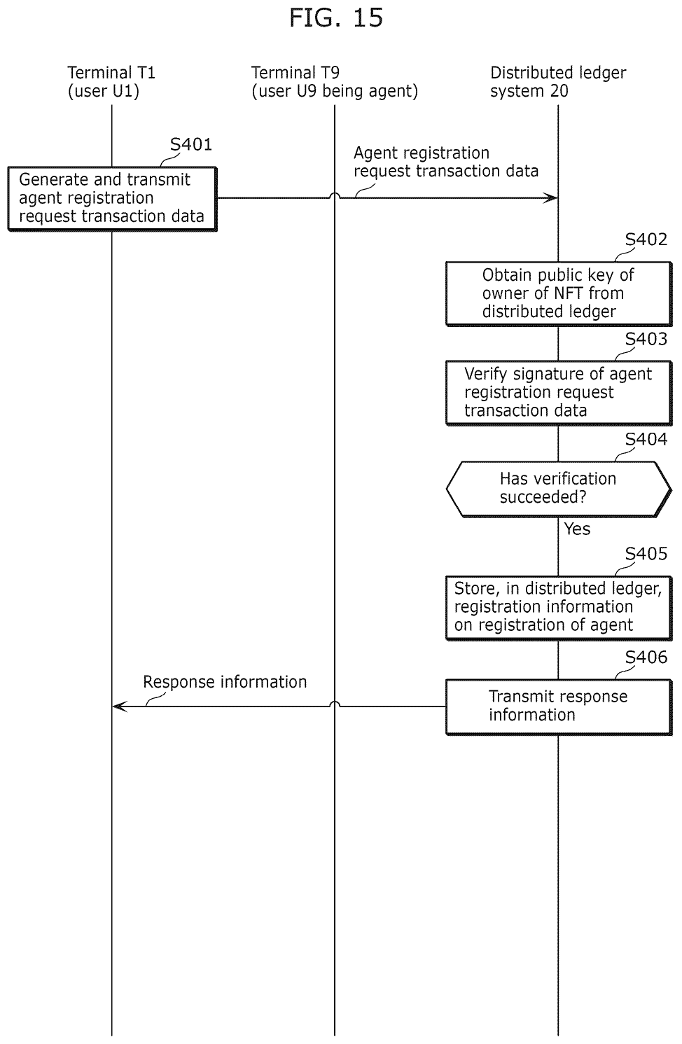

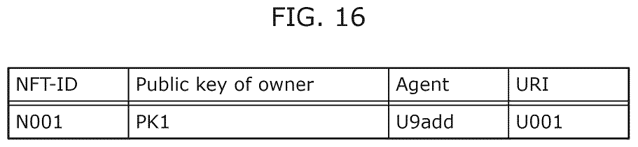

FIG. 15 is a sequence diagram illustrating the process of registering the agent by information processing system 1 in the present variation. FIG. 16 is an explanatory diagram illustrating registration information on the NFT in the present variation. With reference to FIG. 15 and FIG. 16, the process of registering the agent by information processing system 1 will be described.

In step S401, terminal T1 generates agent registration request transaction data and transmits the generated agent registration request transaction data to ledger server 21. Ledger server 21 receives the transmitted agent registration request transaction data and causes ledger processor 202 to store the received agent registration request transaction data in distributed ledger 211. The agent registration request transaction data includes an NFT-ID, identification information on the agent as agent information (more specifically, an address of the agent in distributed ledger system 20), and signature S of user U1 (SK1).

In step S402, in response to the reception of the agent registration request transaction data in step S401, executor 203 of ledger server 21 obtains public key PK1 as the public key of the owner of the NFT from distributed ledger 211.

In step S403, executor 203 of ledger server 21 verifies the signature of the agent registration request transaction data received in step S401.

In step S404, executor 203 of ledger server 21 determines whether the verification in step S403 has succeeded. When determining that the verification has succeeded (Yes in step S404), executor 203 of ledger server 21 proceeds to step S405, and when determining that the verification has failed, executor 203 of ledger server 21 can execute an error process. Note that the illustration of a process performed when it is determined that the verification has failed is omitted for the sake of convenience. The error process may include a process of outputting information indicating that the verification has failed or a process of discarding the transfer request transaction data. The execution of the process of discarding the transfer request transaction data causes the transfer request transaction data not to be stored in a memory. It is thus possible to reduce unnecessary memory usage.

In step S405, executor 203 of ledger server 21 causes ledger processor 202 to store registration information for registering the agent based on the agent information included in the agent registration request transaction data received in step S401 in distributed ledger 211. An example of the registration information in which the agent is registered is illustrated in FIG. 16. In the registration information illustrated in FIG. 16, N001, which is the NFT-ID, is associated with public key PK1 of user U1 as the public key of the owner of the NFT and is associated with the address “U9add” of user U9 as the agent.

In step S406, executor 203 of ledger server 21 transmits response information to terminal T1. Terminal T1 receives the transmitted response information. Executor 203 of ledger server 21 can execute the transmission of the response information as a response to the reception of the agent registration request transaction data in step S402.

Note that the process performed by executor 203 (specifically, steps S402 to S406) may be performed by the execution of a smart contract. In this case, the agent registration request transaction data transmitted in step S401 includes instructions to execute the smart contract for executing the process, and executor 203 can execute the process according to the instructions in response to the storing of the received agent registration request transaction data in distributed ledger 211 (step S401).

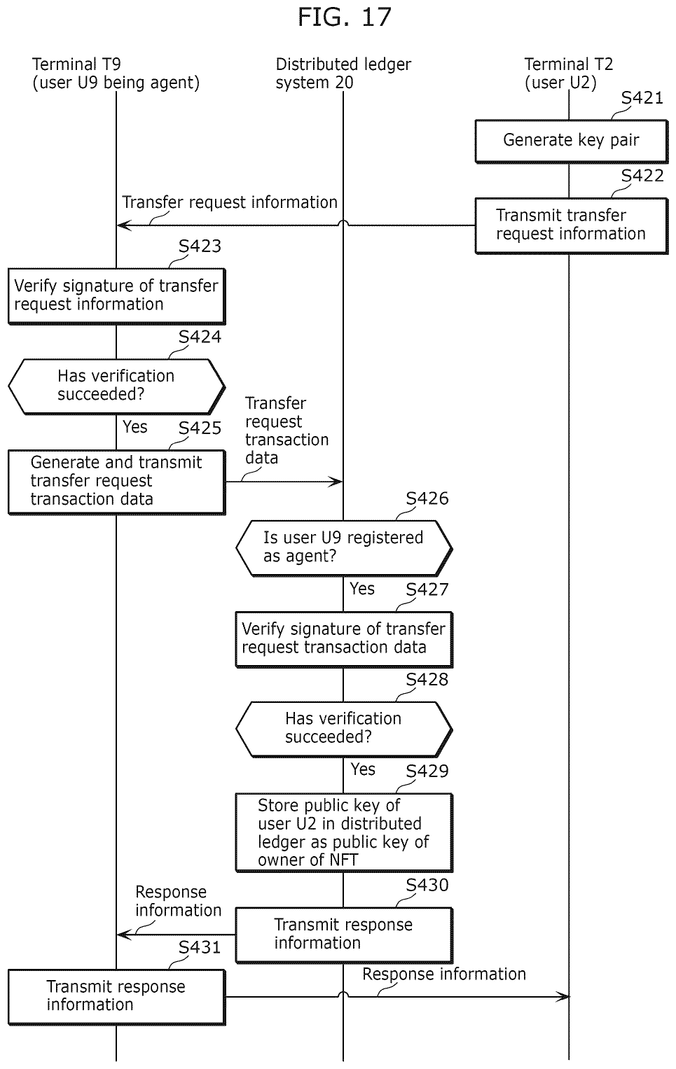

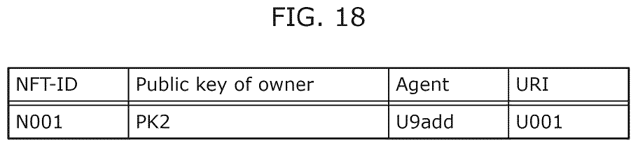

FIG. 17 is a sequence diagram illustrating the process performed by information processing system 1 to transfer the NFT in the present variation. FIG. 18 is an explanatory diagram illustrating registration information on the NFT in the present variation. With reference to FIG. 17 and FIG. 18, the process performed by information processing system 1 to transfer the NFT will be described.

In step S421, terminal T2 generates a key pair of user U2. The generated key pair is a pair of private key SK2 and public key PK2.

In step S422, terminal T2 generates transfer request information and transmits the generated transfer request information to terminal T9. Terminal T9 receives the transmitted transfer request information. The transfer request information includes public key PK2 of user U2 and signature S (SK2) generated using private key SK2 of user U2.

In step S423, terminal T9 verifies the signature of the transfer request information received in step S422.

In step S424, terminal T9 determines whether the verification in step S423 has succeeded. When determining that the verification has succeeded (Yes in step S424), terminal T9 proceeds to step S425, and when determining that the verification has failed, terminal T9 can execute an error process. Note that the illustration of a process performed when it is determined that the verification has failed is omitted for the sake of convenience. The error process may include a process of outputting information indicating that the verification has failed.

In step S425, terminal T9 generates transfer request transaction data and transmits the generated transfer request transaction data to ledger server 21. Ledger server 21 receives the transmitted transfer request transaction data and causes ledger processor 202 to store the received transfer request transaction data in distributed ledger 211. The transfer request transaction data includes an NFT-ID, public key PK2 of user U2, and signature S (SK2).

In step S426, executor 203 of ledger server 21 determines whether user U9 is registered as the agent for the transfer of the NFT. Specifically, ledger server 21 can determine whether user U9 is registered as the agent for the transfer of the NFT by determining whether the address of user U9 is registered as the agent in the registration information with reference to distributed ledger 211. When it is determined that user U9 is registered as the agent for the transfer of the NFT, the process proceeds to step S427, and when it is determined that user U9 is not registered as the agent for the transfer, an error process can be executed. Note that the illustration of a process performed when it is determined that user U9 is not registered as the agent for the transfer is omitted for the sake of convenience. The error process may include a process of outputting information indicating that the process of transferring the NFT has failed.

In step S427, executor 203 of ledger server 21 verifies the signature of the transfer request transaction data received in step S425. At this time, ledger server 21 verifies signature S (SK2) in the transfer request transaction data.

In step S428, executor 203 of ledger server 21 determines whether the verification in step S427 has succeeded. When determining that the verification has succeeded (Yes in step S428), executor 203 of ledger server 21 proceeds to step S429, and when determining that the verification has failed, executor 203 of ledger server 21 can execute an error process. Note that the illustration of a process performed when it is determined that the verification has failed is omitted for the sake of convenience. The error process may include a process of outputting information indicating that the verification has failed or a process of discarding the transfer request transaction data. The execution of the process of discarding the transfer request transaction data causes the transfer request transaction data not to be stored in a memory. It is thus possible to reduce unnecessary memory usage.

In step S429, executor 203 of ledger server 21 causes ledger processor 202 to store public key PK2 of user U2 included in the transfer request transaction data received in step S425 in distributed ledger 211 as the public key of the owner of the NFT. An example of the registration information in which public key PK2 of user U2 is registered as the public key of the owner of the NFT is illustrated in FIG. 18. In FIG. 18, N001, which is the NFT-ID, is associated with the address “U9add” of user U9 as the agent and is associated with public key PK2 of user U2 as the public key of the owner of the NFT.

In step S430, ledger server 21 transmits response information to terminal T9. Terminal T9 receives the transmitted response information. The response information is information indicating that public key PK2 of user U2 has been stored in distributed ledger 211 as the public key of the owner of the NFT. Ledger server 21 can execute the transmission of the response information as a response to the reception of the transfer request transaction data in step S425.

In step S431, terminal T9 transmits the response information to terminal T2. Terminal T2 receives the transmitted response information. Terminal T9 can execute the transmission of the response information as a response to the reception of the transfer request information in step S422.

Note that the process performed by executor 203 (specifically, steps S426 to S430) may be performed by the execution of a smart contract. In this case, the transfer request transaction data transmitted in step S425 includes instructions to execute the smart contract for executing the process, and executor 203 can execute the process according to the instructions in response to the storing of the received transfer request transaction data in distributed ledger 211 (step S425).

As seen from the above, information processing system 1 is capable of transferring an NFT while protecting information about a user.

### Variation 2 of Embodiment 1

In the present variation, remittance processing using an NFT-ID will be described.

In the present variation, information processing system 1 performs remittance processing using the NFT-ID as a remittee. The remittance processing performed using the NFT-ID as a remittee disallows a user browsing the distributed ledger to directly find a user who makes the remittance or a user who receives the remittance. Thus, information about the users is protected.

Note that, remittance processing using a conventional distributed ledger system typically uses an address of a user in the distributed ledger system as a remittee. In this case, a user browsing the distributed ledger can directly find a user who performs the remittance or a user who receives the remittance. Therefore, information about the users is not fully protected.

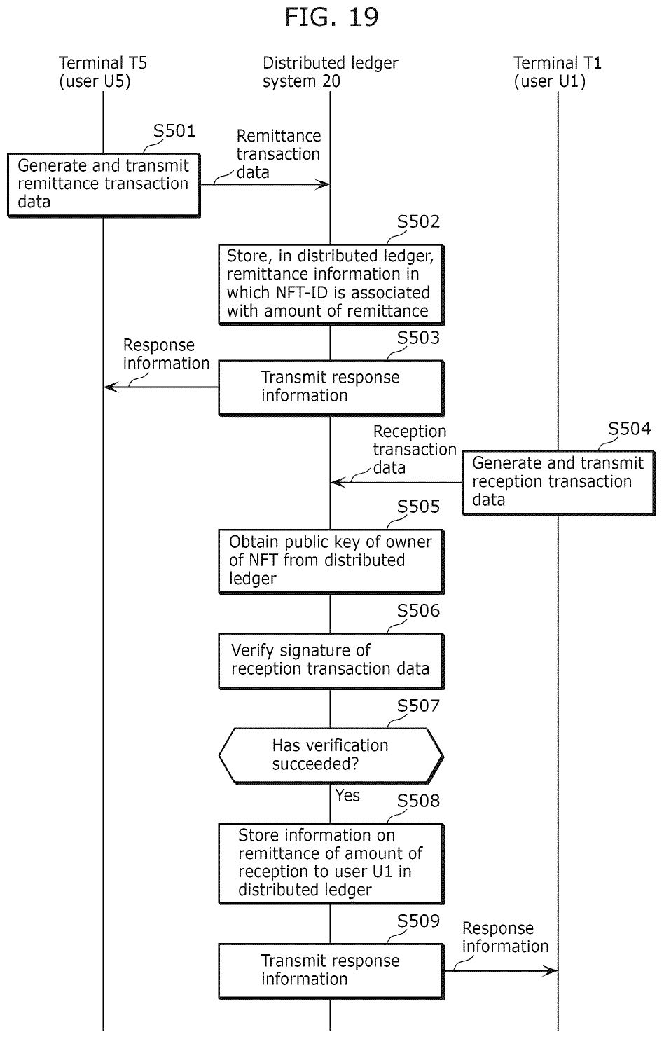

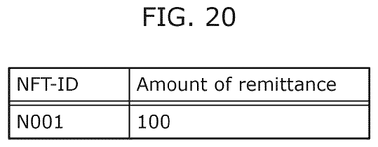

FIG. 19 is a sequence diagram illustrating the process of performing the remittance processing by information processing system 1 in the present variation. FIG. 20 is an explanatory diagram illustrating remittance information in the present variation.

The case where user U5 makes a remittance to user U1 as the owner of the NFT. The making of a remittance refers to transmitting a token, in other words, value information (a monetary value or information equivalent to a monetary value) from one user to another user.

In step S501, terminal T5 generates remittance transaction data and transmits the generated remittance transaction data to ledger server 21. Ledger server 21 receives the transmitted remittance transaction data and stores the received remittance transaction data in distributed ledger 211. The remittance transaction data includes the NFT-ID and the amount of the remittance.

In step S502, in response to the reception of the remittance transaction data in step S501, executor 203 of ledger server 21 stores remittance information in which the NFT-ID and the amount of the remittance included in the remittance transaction data are associated with each other in distributed ledger 211. For example, an example of the remittance information on a remittance in which the token “100” is sent to the remittee “N001,” which is the NFT-ID, is illustrated in FIG. 20.

In step S503, executor 203 of ledger server 21 transmits response information to terminal T5. Terminal T5 receives the transmitted response information. The response information is information indicating that the remittance information has been stored in distributed ledger 211. Ledger server 21 can execute the transmission of the response information as a response to the reception of the remittance transaction data in step S501.

In step S504, terminal T1 generates reception transaction data and transmits the generated reception transaction data to ledger server 21. Ledger server 21 receives the transmitted reception transaction data and causes ledger processor 202 to store the received reception transaction data in distributed ledger 211. The reception transaction data includes the NFT-ID, the amount of the reception, and signature S (SK1).

Note that the amount of the reception may be equal to the amount of the remittance included in the remittance transaction data or may be smaller than the amount of the remittance.

In step S505, executor 203 of ledger server 21 obtains public key PK1 as the public key of the owner of the NFT from distributed ledger 211. When ledger server 21 obtains the public key of the owner of the NFT from distributed ledger 211, distributed ledger 211 obtains public key PK1 of user U1, as the public key of the owner that is associated, in the registration information, with the NFT-ID included in the reception transaction data received in step S504.

In step S506, executor 203 of ledger server 21 verifies the signature of the reception transaction data received in step S504.

In step S507, executor 203 of ledger server 21 determines whether the verification in step S506 has succeeded. When determining that the verification has succeeded (Yes in step S507), executor 203 of ledger server 21 proceeds to step S508, and when determining that the verification has failed, executor 203 of ledger server 21 can execute an error process. Note that the illustration of a process performed when it is determined that the verification has failed is omitted for the sake of convenience. The error process may include a process of outputting information indicating that the verification has failed or a process of discarding the transfer request transaction data. The execution of the process of discarding the transfer request transaction data causes the transfer request transaction data not to be stored in a memory. It is thus possible to reduce unnecessary memory usage.

In step S508, executor 203 of ledger server 21 causes ledger processor 202 to store, in distributed ledger 211, information on the remittance of a token equivalent to the amount of the reception included in the reception transaction data received in step S504 to user U1.

In step S509, executor 203 of ledger server 21 transmits response information to terminal T1. Terminal T1 receives the transmitted response information. The response information is information indicating that the information indicating the token equivalent to the amount of the reception having been remitted to user U1 has been stored in distributed ledger 211. Ledger server 21 can execute the transmission of the response information as a response to the reception of the remittance transaction data in step S504.

Note that the process performed by executor 203 (specifically, steps S502 to S503) may be performed by the execution of a smart contract. In this case, the remittance transaction data transmitted in step S501 includes instructions to execute the smart contract for executing the process, and executor 203 can execute the process according to the instructions in response to the storing of the received remittance transaction data in distributed ledger 211 (step S501).

The process performed by executor 203 (specifically, steps S505 to S509) may be performed by the execution of a smart contract. In this case, the reception transaction data transmitted in step S504 includes instructions to execute the smart contract for executing the process, and executor 203 can execute the process according to the instructions in response to the storing of the received reception transaction data in distributed ledger 211 (step S504).

As seen from the above, information processing system 1 is capable of performing the remittance processing using the NFT-ID as the remittee, thereby performing remittance processing between users while protecting information about the users.

### Embodiment 2

In the present embodiment, an information processing system capable of presenting an NFT while protecting information about a user will be described.

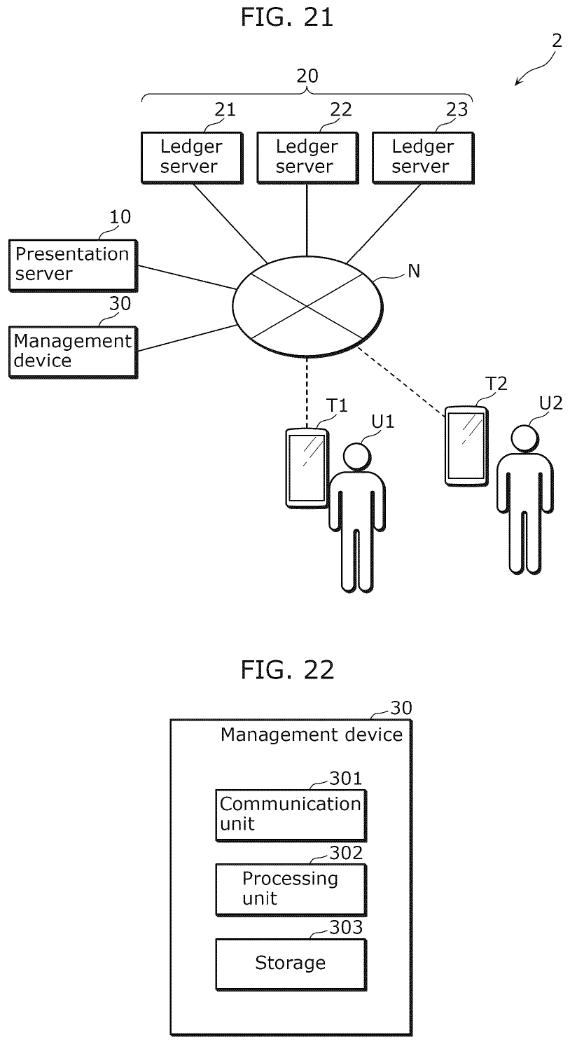

FIG. 21 is a schematic diagram illustrating the general configuration of information processing system 2 in the present embodiment.

As illustrated in FIG. 21, information processing system 2 includes presentation server 10, distributed ledger system 20, management device 30, and terminal T1. Information processing system 2 differs from information processing system 1 in that management device 30 is included. The other points are the same as with information processing system 1. Management device 30 will be described below.

FIG. 22 is a block diagram illustrating the functional configuration of management device 30 in the present embodiment.

As illustrated in FIG. 22, management device 30 includes, as functional units, communication unit 301, processing unit 302, and storage 303. Processing unit 302 and storage 303 can be implemented by a processor (e.g., a Central Processing Unit (CPU)) included in management device 30 executing a given computer program using a memory.

Communication unit 301 is a communication interface that is connected to network N so as to perform communication. Communication unit 301 may be a communication interface conforming to a wired communication standard (e.g., Ethernet (Registered Trademark), etc.), a communication interface conforming to a wireless communication standard (e.g., Wi-Fi (Registered Trademark), etc., or a mobile communications system (3G, 4G, or 5G, etc.)). Communication unit 301 is used when functional units included in management device 30 communicate with another device.

Processing unit 302 performs information processing pertaining to the management of an NFT. The specific details of the information processing performed by processing unit 302 will be described in detail later.

Storage 303 is a storage capable of storing information or data securely. Storage 303 can be a storage area included in a piece of hardware (secure element) that is more secure than a typical piece of hardware in a computer.

Hereinafter, processes by information processing system 2 will be described specifically. The processes by information processing system 2 include (1) the process of registering an NFT, (2) the process of transferring the NFT, and (3) the process of presenting the NFT.

### (1) Process of Registering NFT

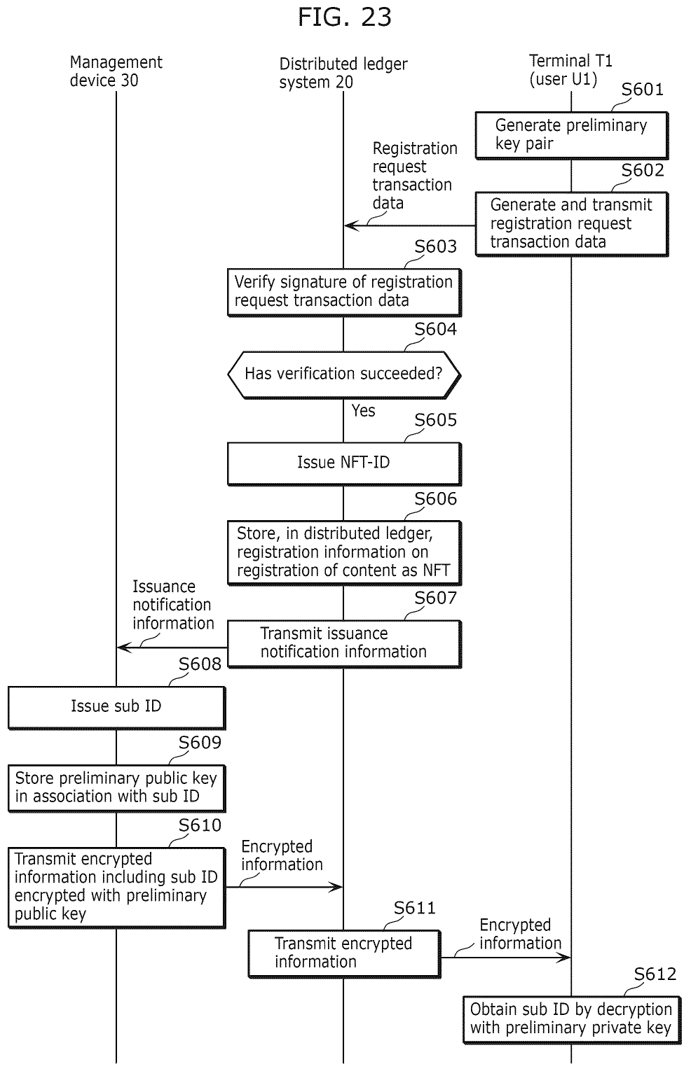

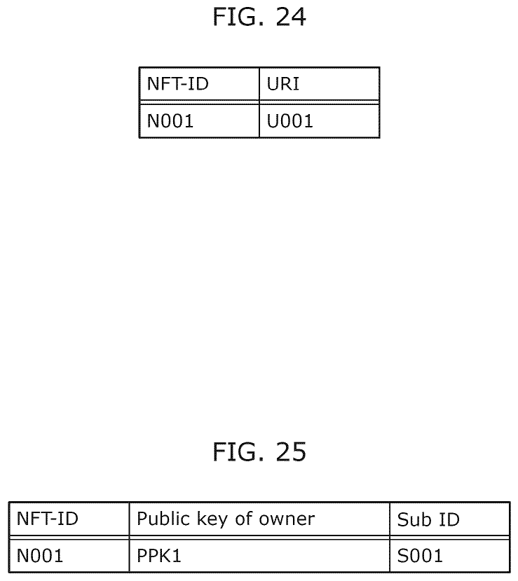

FIG. 23 is a first sequence diagram illustrating the process performed by information processing system 2 to register the NFT in the present embodiment. FIG. 24 is an explanatory diagram illustrating registration information on the NFT in the present embodiment. FIG. 25 is an explanatory diagram illustrating sub-registration information on the NFT in the present embodiment. With reference to FIG. 23 to FIG. 25, the process performed by information processing system 2 to register the NFT will be described.

In step S601, terminal T1 generates a preliminary key pair of user U1. The generated preliminary key pair is a pair of a private key and a public key, which will be referred to as private key PSK1 and public key PPK1, so as to be distinguished from private key SK1 and public key PK1 described later, respectively.

In step S602, terminal T1 generates registration request transaction data and transmits the generated registration request transaction data to ledger server 21. Ledger server 21 receives the transmitted registration request transaction data and causes ledger processor 202 to store the received registration request transaction data in distributed ledger 211.

The registration request transaction data is transaction data including a request for registering the content owned by user U1 as an NFT. The registration request transaction data includes the URI of the content, preliminary public key PPK1 of user U1, and signature S (PSK1) generated using preliminary private key PSK1 of user U1.

In step S603, executor 203 of ledger server 21 verifies the signature of the registration request transaction data received in step S602.

In step S604, executor 203 of ledger server 21 determines whether the verification in step S603 has succeeded. When determining that the verification has succeeded (Yes in step S604), executor 203 of ledger server 21 proceeds to step S605, and when determining that the verification has failed, executor 203 of ledger server 21 can execute an error process. Note that the illustration of a process performed when it is determined that the verification has failed is omitted for the sake of convenience. The error process may include a process of outputting information indicating that the verification has failed.

In step S605, executor 203 of ledger server 21 issues an NFT-ID.

In step S606, executor 203 of ledger server 21 causes ledger processor 202 to store, in distributed ledger 211, registration information on the registration of the content owned by user U1 as the NFT. An example of the registration information stored in distributed ledger 211 by executor 203 is illustrated in FIG. 24. The registration information includes “N001,” which is the NFT-ID of the NFT to be registered and “U001,” which is the URI of the NFT in association with one another.

In step S607, executor 203 of ledger server 21 transmits issuance notification information to management device 30. Management device 30 receives the transmitted issuance notification information. The issuance notification information includes the NFT-ID issued in step S605 and preliminary public key PPK1.

In step S608, processing unit 302 of management device 30 issues a sub ID in response to the reception of the issuance notification information in step S607. The sub ID is an ID temporarily used as identification information on the NFT.

In step S609, processing unit 302 of management device 30 stores preliminary public key PPK1 included in the issuance notification information received in step S607 and the sub ID issued in step S609 in storage 303 in association with each other as the sub-registration information. An example of the sub-registration information is illustrated in FIG. 25. The sub-registration information includes “N001,” which is the NFT-ID of the NFT to be registered, preliminary public key PPK1 of user U1 as the public key of the owner of the NFT, and “S001,” which is the sub ID of the NFT, in association with one another.

In step S610, processing unit 302 of management device 30 transmits encrypted information including the sub ID encrypted with preliminary public key PPK1 to ledger server 21. Ledger server 21 receives the transmitted encrypted information.

In step S611, in response to the reception of the encrypted information in step S610, executor 203 of ledger server 21 transmits the received encrypted information to terminal T1. Terminal T1 receives the transmitted encrypted information.

In step S612, in response to the reception of the encrypted information in step S611, terminal T1 decrypts the received encrypted information with preliminary private key PSK1 of user U1, thus obtaining the sub ID.

Note that the processes performed by executor 203 (specifically, steps S603 to S607 and S610 to S611) may be performed by the execution of a smart contract. In this case, the registration request transaction data transmitted in step S602 includes instructions to execute the smart contract for executing the processes, and executor 203 can execute the processes according to the instructions in response to the storing of the received registration request transaction data in distributed ledger 211 (step S602).

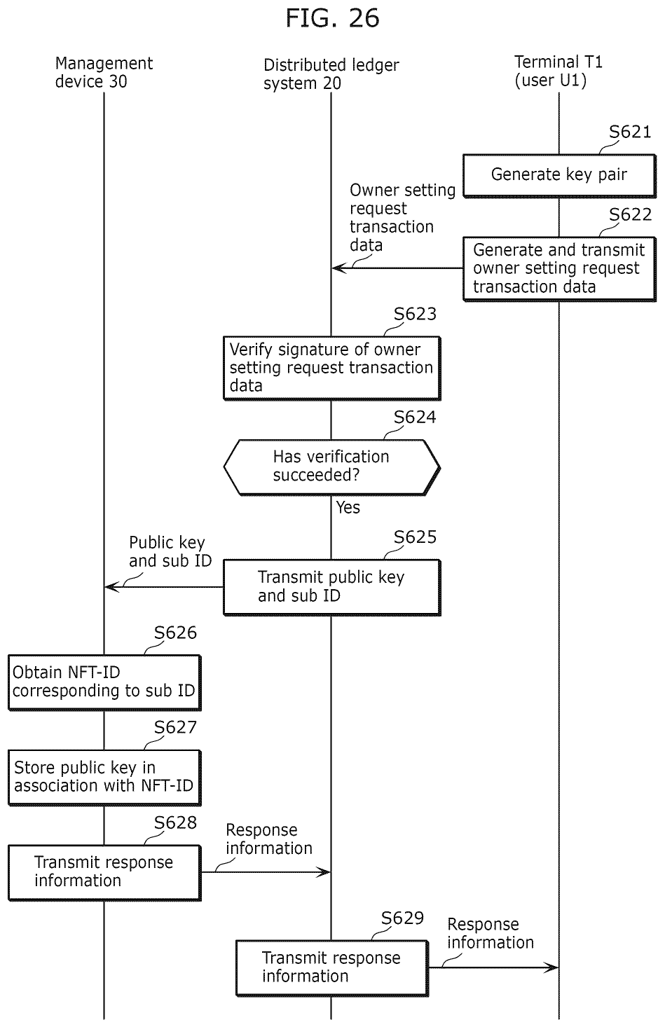

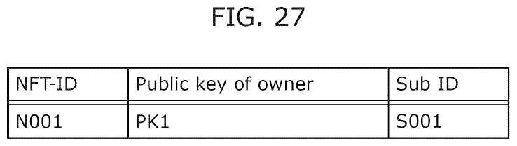

FIG. 26 is a second sequence diagram illustrating the process performed by information processing system 2 to register the NFT in the present embodiment. FIG. 27 is an explanatory diagram illustrating sub-registration information on the NFT in the present embodiment. With reference to FIG. 26 and FIG. 27, the process performed by information processing system 2 to register the NFT will be described.

In step S621, terminal T1 generates a key pair of user U1. The generated key pair is a pair of private key SK1 and public key PK1.

In step S622, terminal T1 generates owner setting request transaction data and transmits the generated owner setting request transaction data to ledger server 21. Ledger server 21 receives the transmitted owner setting request transaction data and causes ledger processor 202 to store the received owner setting request transaction data in distributed ledger 211. The owner setting request transaction data includes the sub ID, public key PK1, and signature S (SK1).

In step S623, executor 203 of ledger server 21 verifies the signature of the owner setting request transaction data received in step S622.

In step S624, executor 203 of ledger server 21 determines whether the verification in step S623 has succeeded. When determining that the verification has succeeded (Yes in step S624), executor 203 of ledger server 21 proceeds to step S625, and when determining that the verification has failed, executor 203 of ledger server 21 can execute an error process. Note that the illustration of a process performed when it is determined that the verification has failed is omitted for the sake of convenience. The error process may include a process of outputting information indicating that the verification has failed.

In step S625, executor 203 of ledger server 21 transmits public key PK1 of user U1 and the sub ID to management device 30. Management device 30 receives the transmitted public key PK1 and sub ID and stores them in storage 303.

In step S626, processing unit 302 of management device 30 reads and obtains the NFT-ID corresponding to the sub ID stored in storage 303 in response to the reception of public key PK1 and the sub ID in step S625.

In step S627, processing unit 302 of management device 30 stores, as the sub-registration information, the public key received in step S625 and the NFT-ID obtained in step S626 in storage 303 in association with each other. An example of the sub-registration information stored in storage 303 is illustrated in FIG. 27. The sub-registration information illustrated in FIG. 27 includes “N001,” which is the NFT-ID of the NFT to be registered, public key PK1 of user U1 as the public key of the owner of the NFT, and “S001,” which is the sub ID of the NFT, in association with one another.

In step S628, processing unit 302 of management device 30 transmits response information to ledger server 21. Ledger server 21 receives the transmitted response information. The response information includes information indicating that the public key of user U1 has been stored in management device 30 in association with the NFT-ID. Management device 30 can execute the transmission of the response information as a response to the reception of the public key and the sub ID in step S625.

In step S629, executor 203 of ledger server 21 transmits response information to terminal T1. Terminal T1 receives the transmitted response information. The response information includes information indicating that the public key of user U1 has been stored in management device 30 in association with the NFT-ID, as with the response information transmitted by management device 30 to ledger server 21. Ledger server 21 can execute the transmission of the response information as a response to the reception of the owner setting request transaction data in step S622.

Note that the processes performed by executor 203 (specifically, steps S623 to S625 and S628 to S629) may be performed by the execution of a smart contract. In this case, the owner setting request transaction data transmitted in step S622 includes instructions to execute the smart contract for executing the processes, and executor 203 can execute the processes according to the instructions in response to the storing of the received owner setting request transaction data in distributed ledger 211 (step S622).

### (2) Process of Transferring NFT

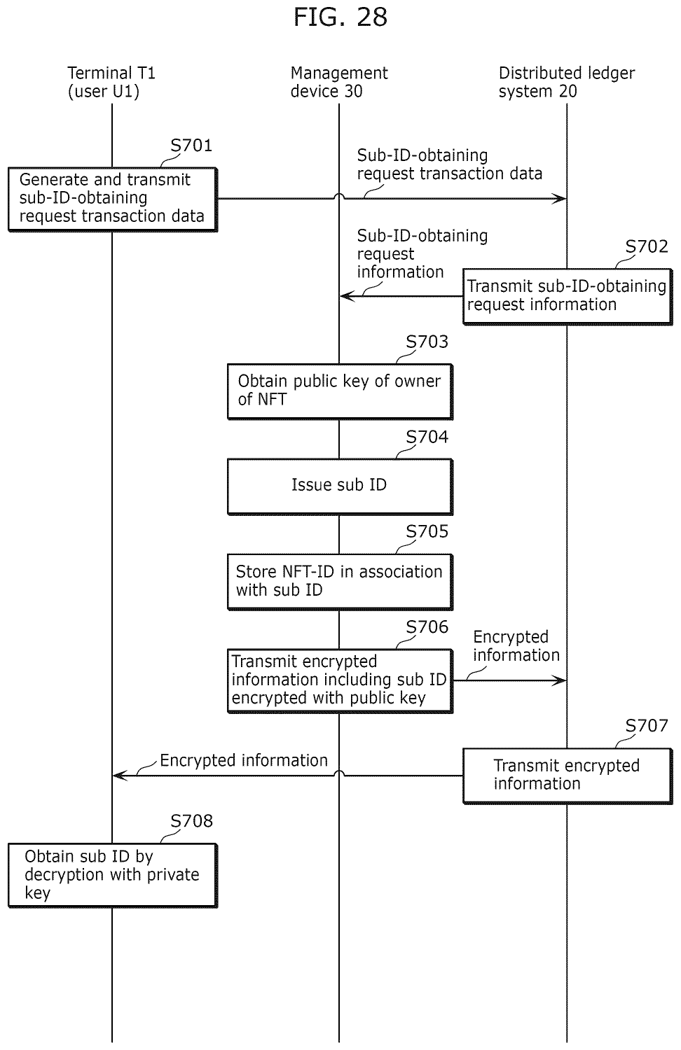

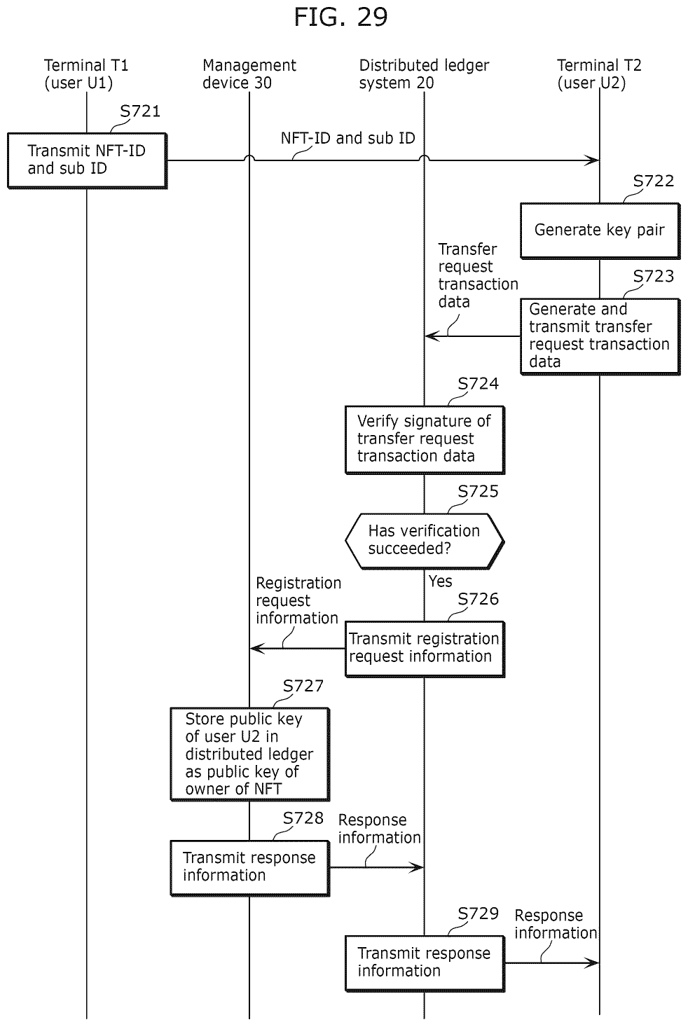

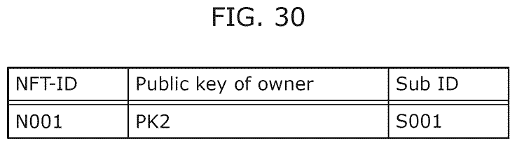

FIG. 28 and FIG. 29 are sequence diagrams each illustrating the process performed by information processing system 2 to transfer the NFT in the present embodiment. FIG. 30 is an explanatory diagram illustrating sub-registration information on the NFT in the present embodiment. With reference to FIG. 28 and FIG. 30, the process performed by information processing system 2 to transfer the NFT will be described.

In step S701 illustrated in FIG. 28, terminal T1 generates sub-ID-obtaining request transaction data and transmits the generated sub-ID-obtaining request transaction data to ledger server 21. Ledger server 21 receives the transmitted sub-ID-obtaining request transaction data and causes ledger processor 202 to store the received sub-ID-obtaining request transaction data in distributed ledger 211.

The sub-ID-obtaining request transaction data is transaction data for requesting a sub ID associated with the NFT-ID. The sub-ID-obtaining request transaction data includes the NFT-ID of the NFT, which is the target to be transferred.

In step S702, executor 203 of ledger server 21 transmits sub-ID-obtaining request information to management device 30 in response to the reception of the sub-ID-obtaining request transaction data in step S701. Management device 30 receives the transmitted sub-ID-obtaining request information. The sub-ID-obtaining request information is information for requesting the issuance of the sub ID. The sub-ID-obtaining request information includes the NFT-ID of the NFT, which is the target to be transferred.

In step S703, processing unit 302 of management device 30 obtains public key PK1 as the public key of the owner of the NFT from storage 303 in response to the reception of the sub-ID-obtaining request information in step S702. When obtaining public key PK1 as the public key of the owner of the NFT from storage 303, processing unit 302 of management device 30 obtains the sub ID that is associated in the sub-registration information with the NFT-ID included in the sub-ID-obtaining request information received in step S702.

In step S704, processing unit 302 of management device 30 issues the sub ID.

In step S705, processing unit 302 of management device 30 stores the NFT-ID included in the sub ID issue request information received in step S702 and the sub ID issued in step S704 in storage 303 in association with each other.

In step S706, processing unit 302 of management device 30 transmits encrypted information including the sub ID encrypted with public key PK1 to ledger server 21. Ledger server 21 receives the transmitted encrypted information.

In step S707, in response to the reception of the encrypted information in step S706, executor 203 of ledger server 21 transmits the received encrypted information to terminal T1. Terminal T1 receives the transmitted encrypted information.

In step S708, in response to the reception of the encrypted information in step S707, terminal T1 decrypts the received encrypted information with private key SK1 of user U1, thus obtaining the sub ID.

Note that the processes performed by executor 203 (specifically, steps S702 and S706 to S707) may be performed by the execution of a smart contract. In this case, the sub-ID-obtaining request transaction data transmitted in step S701 includes instructions to execute the smart contract for executing the processes, and executor 203 can execute the processes according to the instructions in response to the storing of the received sub-ID-obtaining request transaction data in distributed ledger 211 (step S701).

In step S721 illustrated in FIG. 29, terminal T1 transmits the NFT-ID of the NFT, which is the target to be transferred, and the sub ID to terminal T2. Terminal T2 receives the transmitted NFT-ID and the sub ID.

In step S722, terminal T2 generates a key pair of user U2. The generated key pair is a pair of private key SK2 and public key PK2.

In step S723, terminal T2 generates transfer request transaction data and transmits the generated transfer request transaction data to ledger server 21. Ledger server 21 receives the transmitted transfer request transaction data and causes ledger processor 202 to store the received transfer request transaction data in distributed ledger 211. The transfer request transaction data includes the sub ID, public key PK2 of user U2, and signature S (SK2).

In step S724, executor 203 of ledger server 21 verifies signature S (SK2) of the transfer request transaction data received in step S723.

In step S725, executor 203 of ledger server 21 determines whether the verification in step S724 has succeeded. When determining that the verification has succeeded (Yes in step S725), executor 203 of ledger server 21 proceeds to step S726, and when determining that the verification has failed, executor 203 of ledger server 21 can execute an error process. Note that the illustration of a process performed when it is determined that the verification has failed is omitted for the sake of convenience. The error process may include a process of outputting information indicating that the verification has failed.

In step S726, executor 203 of ledger server 21 transmits registration request information to management device 30. Management device 30 receives the transmitted registration request information. The registration request information is information including a request for registering the public key of user U2 in association with the public key of the owner of the NFT. The registration request information includes the sub ID and the public key of user U2.

In step S727, processing unit 302 of management device 30 registers, as the sub-registration information, the public key of user U2 received in step S726 to storage 303 in association with the sub ID received in step S726. At this point, with the NFT-ID and the sub ID registered in association with each other, the registration brings the sub-registration information into the state where the public key of user U2 is registered in association with the NFT-ID. An example of the sub-registration information stored in storage 303 is illustrated in FIG. 30. The sub-registration information illustrated in FIG. 30 includes “N001,” which is the NFT-ID of the NFT to be registered, public key PK2 of user U2 as the public key of the owner of the NFT, and “S001,” which is the sub ID of the NFT, in association with one another.

In step S728, processing unit 302 of management device 30 transmits response information to ledger server 21. Ledger server 21 receives the transmitted response information. The response information includes information indicating that the public key of user U2 has been stored in management device 30 in association with the NFT-ID. The response information does not include the association of the public key of user U2 with the NFT-ID. Management device 30 can execute the transmission of the response information as a response to the reception of the registration request information in step S726.

In step S729, executor 203 of ledger server 21 transmits response information to terminal T2. Terminal T2 receives the transmitted response information. The response information includes information indicating that the public key of user U2 has been stored in management device 30 in association with the NFT-ID, as with the response information transmitted by management device 30 to ledger server 21. Ledger server 21 can execute the transmission of the response information as a response to the reception of the transfer request transaction data in step S723.

Note that the processes performed by executor 203 (specifically, steps S724 to S726 and S728 to S729) may be performed by the execution of a smart contract. In this case, the transfer request transaction data transmitted in step S723 includes instructions to execute the smart contract for executing the processes, and executor 203 can execute the processes according to the instructions in response to the storing of the received transfer request transaction data in distributed ledger 211 (step S723).

### (3) Process of Presenting NFT

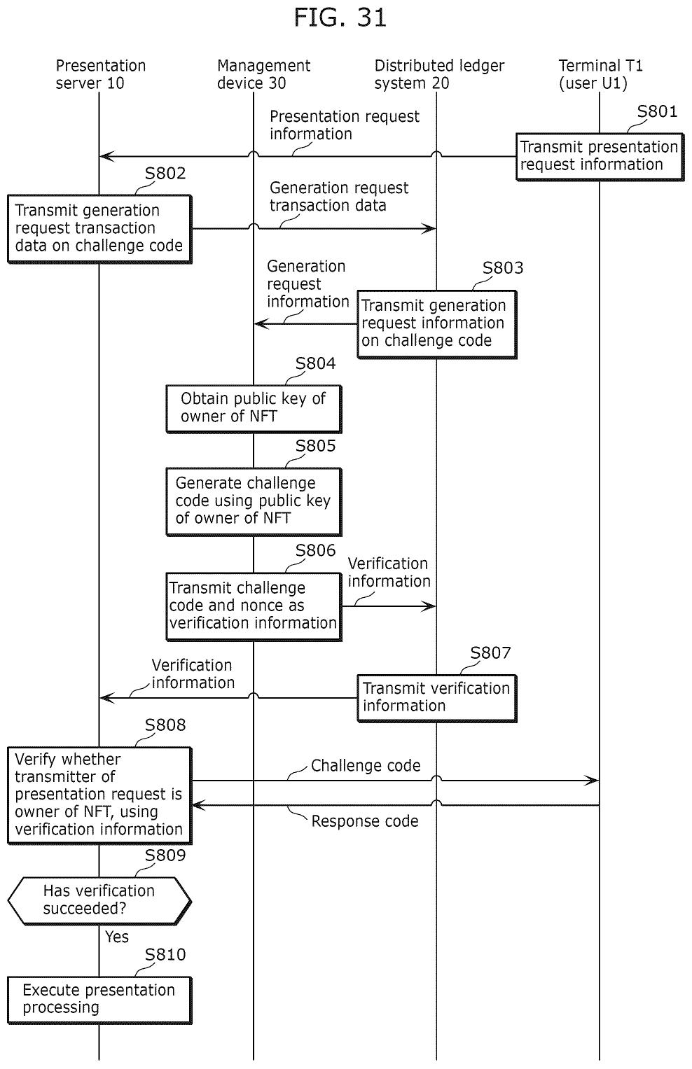

FIG. 31 is a sequence diagram illustrating the process performed by information processing system 2 to present the NFT in the present embodiment.

In step S801, terminal T1 transmits presentation request information on the NFT to presentation server 10. Presentation server 10 receives the transmitted presentation request information. The presentation request information includes identification information on a transmitter of the presentation request, the address of a smart contract, and the NFT-ID of the NFT that is the target to be presented in response to the presentation request.

In step S802, terminal T1 transmits generation request transaction data on a challenge code to ledger server 21 in response to the reception of the presentation request information in step S801. Ledger server 21 receives the transmitted generation request transaction data and causes ledger processor 202 to store the received generation request transaction data in distributed ledger 211. The generation request transaction data includes the NFT-ID.

In step S803, executor 203 of ledger server 21 transmits generation request information on the challenge code to management device 30 in response to the reception of the generation request transaction data in step S802. Management device 30 receives the transmitted generation request information. The generation request information includes the NFT-ID.

In step S804, processing unit 302 of management device 30 obtains public key PK1 as the public key of the owner of the NFT from storage 303 in response to the reception of the generation request information in step S803. When obtaining public key PK1 as the public key of the owner of the NFT from storage 303, processing unit 302 of management device 30 obtains the sub ID that is associated in the sub-registration information with the NFT-ID included in the generation request information received in step S803.

In step S805, processing unit 302 of management device 30 generates a challenge code using public key PK1 of the owner of the NFT obtained in step S804. When generating the challenge code, processing unit 302 of management device 30 generates a nonce and encrypts the generated nonce with public key PK1 of the owner of the NFT. The challenge code is thus generated.

In step S806, processing unit 302 of management device 30 transmits the challenge code generated in step S805 and the nonce used to generate the challenge code to ledger server 21 as verification information. Ledger server 21 receives the transmitted verification information.

In step S807, ledger server 21 transmits the verification information received in step S806 to presentation server 10. Presentation server 10 receives the transmitted verification information.

In step S808, using the verification information received in step S807, verifier 102 of presentation server 10 verifies whether the transmitter of the presentation request information received in step S801 is the owner of the NFT. The verification can be performed using a challenge-response method. Specifically, verifier 102 of presentation server 10 transmits the challenge code included in the verification information received in step S805 to terminal T1. Terminal T1 decrypts the transmitted challenge code with private key SK1 of user U1 to obtain information and transmits the information to presentation server 10 as a response code. Verifier 102 of presentation server 10 receives the transmitted response code and determines whether the received response code matches the nonce included in the verification information. When determining that the response code matches the nonce, verifier 102 of presentation server 10 determines that the verification succeeds, and when determining that the response code does not match the nonce, verifier 102 of presentation server 10 determines that the verification fails.

In step S809, verifier 102 of presentation server 10 determines whether the verification in step S808 has succeeded. When determining that the verification has succeeded (Yes in step S809), verifier 102 of presentation server 10 proceeds to step S810, and when determining that the verification has failed, verifier 102 of presentation server 10 can execute an error process. Note that the illustration of a process performed when it is determined that the verification has failed is omitted for the sake of convenience. The error process may include a process of outputting information indicating that the verification has failed or a process of presenting the content in a conventional mode.

In step S810, presentation controller 103 of presentation server 10 executes presentation processing of presenting the NFT. The presentation processing is the same as in step S306 (see FIG. 12).

Note that the processes performed by executor 203 (specifically, steps S803 and S806 to S807) may be performed by the execution of a smart contract. In this case, the generation request transaction data transmitted in step S802 includes instructions to execute the smart contract for executing the processes, and executor 203 can execute the processes according to the instructions in response to the storing of the received generation request transaction data in distributed ledger 211 (step S802).

Accordingly, presentation server 10 can obtain the verification information generated using the public key of the owner securely stored in management device 30 and verify whether the transmitter of the received presentation request is the owner by the challenge-response method using the obtained verification information.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory. Here, the software that realizes the information processing device or the like is a program described below.

In other words, this program is a program for causing a computer to execute an information processing method including: receiving a presentation request for presenting a content that is a Non-Fungible Token (NFT); verifying, by using a public key of an owner of the content, whether a transmitter of the presentation request received is the owner of the content; and performing presentation processing for presenting the content, when the transmitter of the presentation request received is verified to be the owner of the content.

Although the information processing method and the like according to one or more aspects of the present disclosure have been described based on embodiments, the present disclosure is not limited to these embodiments. Those skilled in the art will readily appreciate that embodiments arrived at by making various modifications to the above embodiments or embodiments arrived at by selectively combining elements disclosed in the above embodiments without materially departing from the scope of the present disclosure may be included within one or more aspects of the present disclosure.

### INDUSTRIAL APPLICABILITY

The present disclosure is applicable to an information processing system that controls the presentation of an NFT.

1. An information processing method comprising:
receiving a presentation request for presenting a content that is a Non-Fungible Token (NFT);
verifying, by using a public key of an owner of the content, whether a transmitter of the presentation request received is the owner of the content; and
performing presentation processing for presenting the content, when the transmitter of the presentation request received is verified to be the owner of the content.

2. The information processing method according to claim 1, wherein
the presentation request includes identification information for identifying the NFT that is a target to be presented in response to the presentation request, and
the verifying includes:
obtaining the public key of the owner from a distributed ledger in which the public key is stored in association with the identification information included in the presentation request; and
verifying whether a creator of the presentation request received is the owner of the content, by a challenge-response method using the public key obtained.

3. The information processing method according to claim 2, further comprising:
storing the public key used in the verifying as a first public key when the transmitter of the presentation request received is verified to be the owner of the content;
obtaining, as a second public key, the public key of the owner from the distributed ledger in which the public key is stored, when further verifying the owner of the content after the storing of the public key as the first public key;
determining whether the second public key obtained matches the first public key; and
performing presentation processing for presenting the content, when the second public key obtained is determined to match the first public key.

4. The information processing method according to claim 1, wherein
the presentation request includes identification information for identifying the NFT that is a target to be presented in response to the presentation request, and
the verifying includes;
obtaining verification information generated by using the public key of the owner, the public key being securely stored in a storage device; and
verifying whether the transmitter of the presentation request received is the owner, by a challenge-response method using the verification information obtained.

5. An information processing system comprising:
a server; and
a terminal, wherein
the server includes:
a communication unit that receives, from the terminal, a presentation request for presenting a content that is a Non-Fungible Token (NFT);
a verifier that verifies, by using a public key of an owner of the content, whether a transmitter of the presentation request received by the communication unit is the owner of the content; and
a presenter that performs presentation processing for presenting the content by the terminal, when the transmitter of the presentation request received is verified to be the owner of the content.

6. A non-transitory computer-readable recording medium having recorded thereon a computer program for causing a computer to execute the information processing method according to claim 1.
